(19) United States
(12) Patent Application Publication
(10) Pub. No.: US 2006/0191390 A1
(43) Pub. Date: Aug. 31, 2006

(54) Die cutter blanket/anvil locking system

(76) Inventor: Kenneth Ray Neal, Magnolia, TX (US)

Correspondence Address: CARELLA, BYRNE, BAIN, GILFILLAN, CECCHI,;STEWART & OLSTEIN, 5 BECKER FARM ROAD, ROSELAND, NJ, 07068, US

(21) Appl. No.: 11/066,627

(22) Filed: Feb. 25, 2005

(51) Int. Cl. B23D 25/12; B26D 7/20

(52) U.S. Cl. 83/347; 83/348; 83/659

(57) ABSTRACT

Mating abutting male and female locking projections depend from a die cutter blanket at opposite ends. The ends are received in an anvil channel having an arcuate corner surface. The anvil channel has a slot that receives a locking plate lip attached to the female projection in one embodiment to secure the female end. In the alternative, the projection and anvil channel have wedge shaped complementary portions and also may use replaceable strips. A blanket locking mechanism includes tandem primary and secondary air cylinders. The male blanket end has a locking recess that receives a locking mechanism nose. The nose simultaneously circumferentially and radially pulls the male end into the channel by operation of the primary cylinder. A locking bar is rotatably secured to the primary cylinder shaft and slidably rotates about an arcuate surface on a mounting base on the anvil and on an anvil coextensive arcuate surface as the primary cylinder shaft is lowered. The lowered shaft is friction locked with a spring/air operated piston of the secondary cylinder. The spring locks the primary shaft to permit the removal of pressurized air from the cylinders during operation.

This invention relates to securing arrangements for securing a die cutter blanket to an anvil about which the blanket is wrapped for use in a sheet material die cutting apparatus.

### CROSS REFERENCE TO COMMONLY OWNED PATENT OF INTEREST

Of interest is commonly owned U.S. Pat. No. 6,612,214 entitled Die Cutter Blanket-Anvil Locking Arrangement filed in the name of Kenneth R. Neal, the applicant of the present invention.

Die cutter blankets are thermoset molded urethane material that wrap about circular cylindrical reaction structures such as steel anvils. The anvils typically have a longitudinal axially extending bore and a channel in their outer surface extending along the anvil longitudinal axis. The blankets are wrapped about the anvil and have locking projections in some embodiments. The blankets are sheet material with opposing end edges at which the locking projections are located. The ends are complementary and the locking projections engage when inserted into the channel. The locking projections interlock when inserted into the anvil channel, locking the edges to the blanket and locking the blanket to the anvil and precluding the blanket from rotating about the anvil and separating from the anvil.

U.S. Pat. No. 3,765,329 discloses a blanket with such projections. The plastic blanket has a sheet metal inner liner. The locking projections form a two part snap in construction in which a female part receives a male part, the female part depending from the blanket at one end edge thereof with a longitudinal rounded groove and the male part is complementary to the groove and snaps into the groove. The male part may be made of metal. The female part has a metal support. The male and female parts depend from the blanket edge for insertion into the anvil channel.

Other complementary locking structures are shown in U.S. Pat. Nos. 4,073,207, 4,848,204, 3,885,486, 4,867,024, 5,078,535, 5,720,212, 5,758,560, 5,916,346 and 6,135,002. All of the above patents use interlocking complementary depending structures which fit into the anvil channel and cooperate with each other and the anvil channel to lock the blanket ends together and to the anvil in interference fit in the anvil channel. The interlocking structures require the projections to be force fit into the anvil channels to obtain the locking action. Typically the projections are manually hammered into the channel to interlock surface features of the mating projections or to interlock the projections with the channel. In addition, the projections may be bolted to the anvil channel using brackets.

Another locking arrangement for locking blanket ends together employs interlocking fingers which are somewhat dovetail in shape. The interlocking fingers are in the same plane as the blanket sheet material and overlie the anvil. The anvil has a channel. The interlocking fingers overlie the channel. The interlocking finger end portions of the blanket have a depending projection which fits within the anvil channel to preclude the blanket from rotating relative to the anvil. These fingers present problems in that the outer surface of the die cutting blanket is not always smooth as required due to the tendency of the fingers to projection above the curvature of the cylindrical shape of the rest of the blanket thereby causing poor die cuts on the blank material.

The problem with the above constructions is that the locking projections that are inserted into the anvil channels mate typically in interference fit. This has required the projections to be manually hammered into the anvil channel. This is cumbersome. Also, to remove the blanket requires a costly reverse process which is even more difficult because the blanket ends need to by pried out of the anvil channel. This is costly to implement. The present inventor recognizes a need for a simpler and easier to install and remove blanket locking arrangement which is faster and more economical to implement.

A solution to this problem is disclosed by a blanket locking arrangement disclosed in the above-noted commonly owned U.S. Pat. No. 6,612,214 entitled Die Cutter Blanket-Anvil Locking Arrangement filed in the name of the present inventor. In this arrangement, pneumatically operated air cylinders are attached to the anvil. The piston shafts of the cylinders reciprocate radially relative to the outer surface of the air cylinder. The cylinders operate in response to applied pressurized air. The shafts of the cylinders extend in a radial direction in one mode to release the blanket and radially retract in a second mode to lock the blanket to the anvil. The blanket ends have mating projections which form a common recess when mated. The recess is enclosed by a metal angle member secured to each projection. The angle members and projections have a transverse slot for mounting the blanket end which is engaged by a mechanism attached to the air cylinder. A T-bar is attached to the air cylinder shaft releasably simultaneously engages both ends of the blanket by extending through the common recess. A spring normally biases the blanket in the locked state radially relative to the anvil. The projections are held in place in the anvil channel or lifted out of the channel by the air cylinder and T-bar. When lifted out of the channel the blanket projections are manually released from the T-bar.

However, experience has shown that this arrangement is not optimum. The blanket at the mating ends is not and can not be pulled fully into the anvil slot by the cylinder pistons. The blanket thus does not present a fully seated surface abutting the anvil. This is not satisfactory to ensure optimum operation of the cutting dies, providing undesirable product. The outer blanket surface was determined not to be held in place in a manner to provide a smooth continuous uniform die cutting surface on the blanket at the joint provided by the abutting blanket ends. This problem could not be resolved with that technology.

The present inventor, who is the inventor in that prior patent just discussed, discovered that no matter how high a force was applied to the T-bar, the radially force could not completely seat the blanket projections in the anvil channel.

Still other blanket locking devices are shown in various other US patent documents. For example, U.S. Pat. No. 5,284,093 to Guaraldi et al. shows a pneumatically controlled lock-up system for drawing in and retaining the ends of a plate onto a cylinder. This structure is not suitable for a die cutter blanket as there are gaps in the surface unacceptable for a die cutter application.

U.S. Pat. No. 6,588,341 to Hieronymus et al. shows an automated self-locking mechanism for drawing the ends of a “packing” or blanket down onto a printing cylinder. This is not suitable for a die cutter application due to gaps in the surface similar to the '093 patent discussed above.

U.S. Published Appl. No. 2003/0066405 to Harrison shows the use of pressurized air cylinders to secure a rotary cutting die board to a support cylinder. This system is not suitable for use with a blanket that encircles an anvil and that requires a smooth continuous uninterrupted surface. This is because the rotary cutting die board has many openings not desirable for use in die cutting processes for cutting large blanks of paper board. Disclosed is a partial blanket, i.e., a board, that is secured to the anvil over only a portion of the anvil surface. The board needs to be manually shifted so that its slots can engage the bolts attached to the anvil in translation along the anvil surface and which bolts must first pass through the slots. The bolts are then pulled taut against the board by a piston. Once the board is attached to the protruding bolts, it still must be manually shifted in position. The bolts are at the board surface, FIG. 4, and there are undesirable holes in the board surface. In this patent, the body of the board is secured in spaced areas each forming an opening in the board surface, resulting in numerous undesirable openings in the board surface.

U.S. Published Appl. No. 2003/0172826 to Sakamoto shows an air cylinder for opening and closing clamping devices used to secure opposite ends of a printing plate onto a printing cylinder. This arrangement is not suitable for a die cutter blanket as the outer surface of the printing plate when secured is not cylindrical and smooth as required for a die cutter blanket.

U.S. Published Appl. No. 2004/0050276 to Schafer discloses a system for securing the ends of a printing plate about a cylinder. This arrangement is also not suitable for a die cutter blanket since the printing plate has an undesirable gap which is not acceptable for a die cutting system.

The present inventor has discovered a solution to the problem left unsolved by his prior patent No. 6,612,214. In particular, according to the present invention a blanket locking system is for releasably locking a die cutter blanket to an anvil. The system comprises a cylindrical anvil for rotating about an axis and has a channel extending across its outer surface in a direction parallel to the anvil axis of rotation. A die cutter blanket has first and second ends, the blanket for wrapping about and being releasably locked to the outer surface of the anvil in a locked state. The ends abut in the locked state to form a continuous outer cylindrical die cutting reactor surface. A first projection depends from the first blanket end and a second projection depends from the second blanket end. The first projection and the anvil channel are arranged for the first projection to be secured in the channel. The second projection engages the anvil channel in a locked state.

A blanket locking apparatus is secured to the anvil and arranged for selective engagement with the second projection for displacing the engaged second projection into and out of the anvil channel to and from the locked state to thereby lock both projections in the channel.

In one aspect the locking apparatus is arranged for both circumferentially and radially displacing the engaged second projection.

In a further aspect, the anvil has a locking recess in communication with the channel, the first projection having a configuration complementary to the locking recess.

In a further aspect, a locking plate is secured to the first projection for supporting the locked second projection in the channel.

In a further aspect, a locking plate is included for engaging the locking recess to releasably secure the first end to the anvil channel in the locked state.

In a still further aspect, a removable strip is attached to the anvil for forming the locking recess.

Preferably the projections depend from the blanket a maximum given distance, each projection defining a face area over the entire given distance, the face areas mating with each other in abutting non-locking relationship.

A blanket locking system according to a further embodiment of the present invention is where the second projection is engaged with the apparatus secured to the anvil in the unlocked state. The apparatus displaces only the second projection from the unlocked state into the locked state engaged with the channel. This locks the first and second projections in the channel and the blanket ends in abutting relation forming the blanket outer surface into the smooth continuous cylinder. The blanket is released from the anvil by selectively displacing the second projection out of the channel into the unlock state to permit the blanket to be manually released from the apparatus.

In one aspect, the anvil has a locking recess in communication with the channel, a locking plate being secured to the first projection for engaging the locking recess to thereby releasably secure the first end to the anvil channel in the locked state.

In a further aspect, a pneumatic arrangement selectively places the apparatus in the locked and unlocked states.

Preferably the apparatus includes an actuator and a blanket locking bar pivotally secured to the anvil and having a nose arranged to releasably engage a recess in the second projection, the actuator for rotating the locking bar during the displacing of the second projection to and from the locked and unlocked states.

In a further aspect, the anvil channel has an arcuate corner portion surface, the locking bar having an arcuate surface that mates with and slides on the arcuate corner portion surface.

In a further aspect, the apparatus includes a locking bar mounting base secured to the anvil, the mounting base forming the channel arcuate corner portion surface.

In a further aspect, a locking bar is engaged with the second projection and has a second surface that mates with and slides on a mounting base first surface during the displacement to and from the locked and unlocked states, and includes an actuator for displacing the locking bar.

In a further aspect, the first and second surfaces of the mounting base and locking bar are arcuate.

In a still further aspect, the locking bar actuator is pivotally secured to the mounting base.

Preferably, the actuator comprises a reciprocating shaft, the shaft being pivotally secured to the locking bar for displacing the locking bar in response to the reciprocation of the shaft.

More preferably, the actuator is a pneumatically operated air cylinder.

In a further aspect, the air operated cylinder has a first piston and includes a locking cylinder having a second piston for locking the air operated cylinder in the locked state with the second piston engaged with the first piston without the use of air pressure to maintain the locked state of the air operated cylinder.

In a further aspect, a plurality of the apparatuses are secured to the anvil in a linear array. Preferably, a control is included for simultaneous operation of the plurality of apparatuses.

In a further aspect, the apparatus includes a pressurized air operated actuator. A control operates the actuator and is responsive to a first pressurized air source having a first pressure value and a second pressurized air source having a pressure value that is greater than the first pressure value. The second pressure value is used to displace the actuator to the locked state, the first pressure being used to displace the actuator to the unlocked state.

In a still further aspect, at least two identical apparatuses are secured to the anvil at the channel in an array.

Preferably, the blanket and second projection has a locking recess. The apparatus includes an actuator secured to the anvil at the channel. The actuator includes a nose for engaging the locking recess. The nose is attached to a locking bar which is displaced by the actuator between a raised unlocked state and a lowered lock state. In the latter state, the second projection is rotatably drawn into the channel by the locking bar.

Preferably, the actuator includes a pressurized air operated cylinder having a reciprocating shaft, a link pivotally secured to the anvil and to the actuator shaft and fixedly secured to the locking bar wherein reciprocation of the shaft rotates the link and locking bar between the locked and unlocked states.

In a further aspect, the channel has a bottom wall, a surface of the groove and a surface of the bottom wall being coplanar, the bottom wall terminating at an opening in the channel, the opening for receiving a portion of the apparatus, the locking plate having a portion extending over a portion of the opening, the second projection for abutting the locking plate extended portion in the locked state.

In a further aspect, an apparatus for locking a die cutter blanket to a rotatable anvil having a channel in its outer surface extending parallel to the anvil axis of rotation comprises a blanket locking nose element having locked and unlocked states movably secured to the anvil for releasable engagement with only the locking recess of the second end. An actuator is secured to the anvil for selectively displacing the element from the unlocked state into the locked state to lock the first and second projections to the anvil in the anvil channel and for reversing the displacement of the element to an unlocked state for releasing the blanket.

A die cutter blanket according to a further aspect of the invention is for wrapping about a rotatable cylindrical anvil having a channel in its outer peripheral surface extending parallel to the axis of rotation of the anvil. The channel has opposing side walls and a bottom wall having a surface terminating at opposite edges. One edge terminates at the side wall and the opposing edge terminates at an opening in the anvil in communication with the channel. A first recess is in the side wall and has a surface coplanar with the bottom wall surface.

The blanket comprises a sheet material die cutting member having first and second mating ends which abut when wrapped about the anvil to form a circular cylinder. A first projection depends from the first end of the blanket and terminates at a first projection bottom surface. A second projection depends from the blanket second end. A locking plate is secured to and juxtaposed with the first projection bottom surface. The plate extends from the first projection forming an extension. The extension extends beyond the first projection and beyond the first end of the blanket for overlying the opening in the anvil.

The second projection and blanket at the second end have a second recess having an opening thereto facing in a direction away from the first projection. The locking plate extension receives in abutting relationship and supports the second projection over the opening when the member ends abut in the locked state.

### IN THE DRAWING

FIG. 1 is an isometric view of a die cutter blanket locking apparatus attached to a die cutter rotatable anvil according to an embodiment of the present invention;

FIG. 1a is an end sectional elevation view of the anvil of FIG. 2 without the blanket locking apparatus attached taken at lines 1a-1a;

FIG. 1b is an end sectional elevation view of the anvil of FIG. 2 without the blanket locking apparatus attached taken at lines 1b-1b;

FIG. 1c is a fragmented top plan view of a portion of the anvil of FIG. 2 without the blanket apparatuses attached and showing the anvil channels;

FIG. 1d is a fragmented end elevation sectional view of the mating end regions of a representative die cutting blanket according to an embodiment of the present invention for use with the anvils of FIGS. 1, 2, 5; and 6;

FIG. 1e is an isometric fragmented end view of the blanket of FIG. 1d;

FIG. 1f is an end sectional elevation view similar to that of FIG. 1b of an anvil according to a second embodiment;

FIG. 1g is an end sectional elevation view similar to that of FIG. 1b of an anvil according to a third embodiment;

FIG. 1h is a fragmented end sectional view similar to the view of FIG. 1d of a blanket according to a further embodiment;

FIG. 2 is a plan view of the apparatus and anvil of FIG. 1 showing in addition a series of die cutter blankets, in section, wrapped about the anvil;

FIG. 3 is a top plan view of a locking plate that is attached to a blanket to be secured to the anvil by the apparatus of FIG. 1;

FIG. 4 is a side elevation view of the plate of FIG. 3;

FIG. 5 is an isometric view of the locking apparatus of FIG. 1 attached to a shorter in length anvil according to a further embodiment of the present invention;

FIG. 6 is an end elevation view of the anvil and locking apparatus of FIG. 5;

FIG. 7 is a top plan view of the anvil and locking apparatus of FIG. 5 further including a sectional view of die cutter blanket wrapped about the anvil;

FIG. 8 is an isometric view of a blanket locking apparatus according to an embodiment of the present invention prior to installation on an anvil;

FIG. 9 is a side elevation view of the apparatus of FIG. 8;

FIG. 9a is a side elevation view of the locking apparatus in the upper unlocked state similar to the view of FIG. 9 and used to illustrate certain principles of the operation of the locking apparatus;

FIG. 9b is a side elevation view similar to that of FIG. 9a in the lower locked state used to illustrate certain principles of the operation of the locking apparatus;

FIG. 10 is an isometric view of an air cylinder mounting bracket used in the embodiments of FIGS. 8 and 9.

FIG. 11 is a front elevation view of the apparatus of FIGS. 8 and 9;

FIG. 12 an elevation view of a pressurized air supply system for operating the air cylinder of the embodiments of FIGS. 8, 9 and 11;

FIG. 13 is a sectional elevation view of a die cutter blanket mating end region and associated locking apparatus in the locked state of the blanket to the anvil;

FIG. 14 is an isometric view of a blanket locking bar used in the embodiment of FIGS. 8, 9 and 11;

FIG. 15 is a top plan view of the locking bar of FIG. 14;

FIG. 16 is a front elevation view of the locking bar of FIG. 14;

FIG. 17 is a front elevation view of a nose element used with the locking bar of FIGS. 14-16;

FIG. 18 is a top plan view of the nose element of FIG. 17;

FIG. 19 is a sectional end elevation view of the nose element of FIG. 17 taken along lines 19-19;

FIG. 20 is an isometric view of the locking bar of FIG. 14 without the nose element attached;

FIGS. 21 and 22 are respective side sectional elevation views of the locking bar of FIG. 24 taken at respective lines 21-21 and 22-22;

FIG. 23 is a top plan view of the locking bar of FIG. 20;

FIG. 24 is a front elevation view of the locking bar of FIG. 20;

FIG. 25 is a bottom plan view of the locking bar of FIG. 20;

FIG. 26 is a top plan view of the mounting base used in the embodiments of FIGS. 8, 9 and 11;

FIG. 27 is a front elevation view of the mounting base of FIG. 26;

FIG. 28 is a bottom plan view of the mounting base of FIG. 33 taken at lines 28-28;

FIG. 29 is an isometric view of a link used to operate the locking bar of FIG. 14;

FIG. 30 is a top plan view of the link of FIG. 29;

FIG. 31 is a front elevation view of the link of FIG. 29;

FIG. 32 is a side elevation view of the link of FIG. 29;

FIG. 33 is a side elevation view of the mounting base of FIG. 27 taken at lines 33-33;

FIG. 34 is a side elevation sectional view of the mounting base of FIG. 27 taken at lines 34-34;

FIG. 35 is a side elevation sectional partially schematic view of the apparatus and anvil of FIG. 2 and a front elevation view of a pneumatic control panel for operating the air cylinders of the apparatus showing the pneumatic connection of the panel to the apparatus;

FIG. 36 is a schematic diagram showing the pneumatic arrangement depicted in FIG. 35;

FIG. 37 is a diagram showing schematically the sequential steps of the operation of the apparatuses of FIG. 1 or FIG. 5; and

FIGS. 38-48 are more detailed sectional elevation views depicted by corresponding respective steps B-L of FIG. 37.

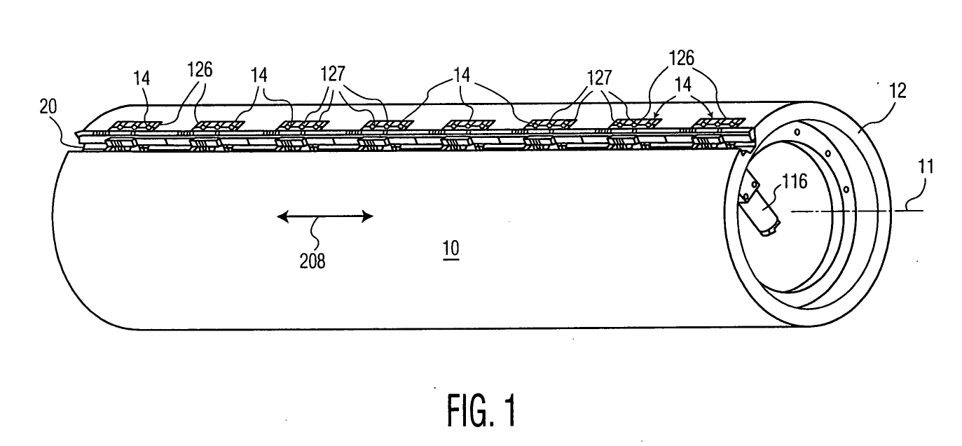

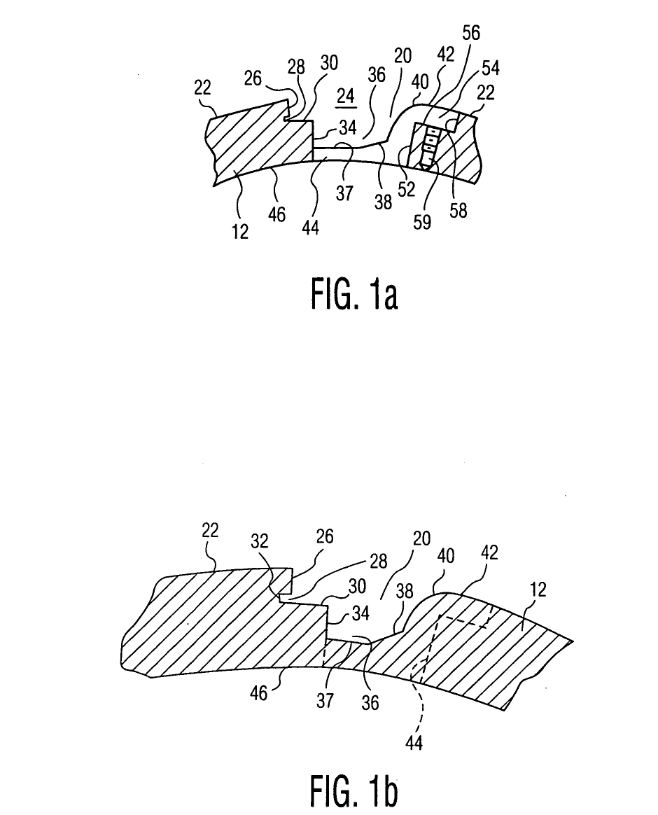

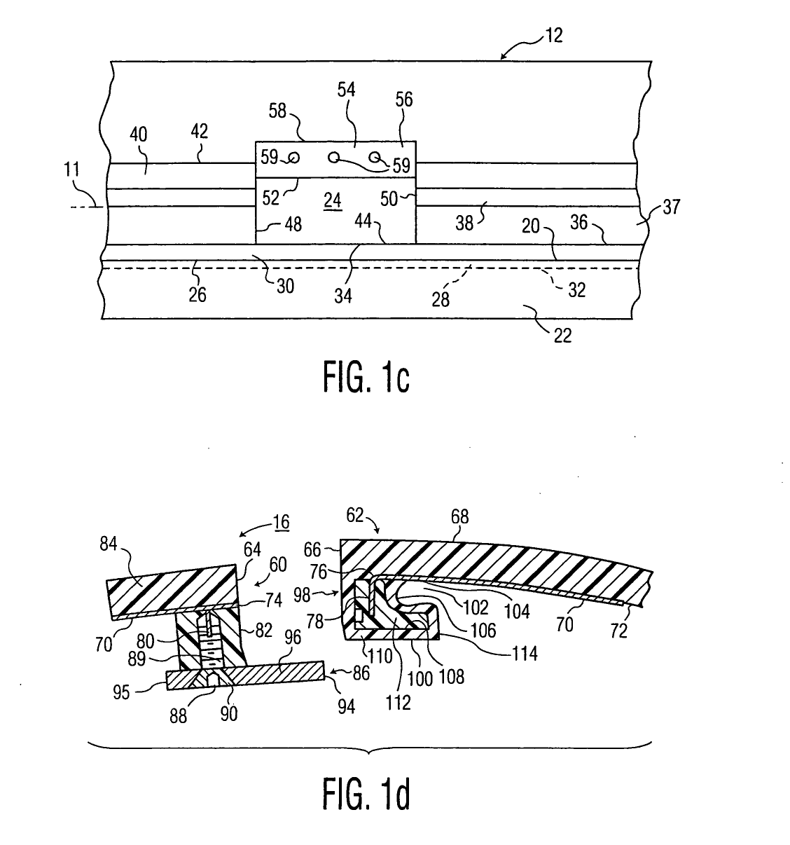

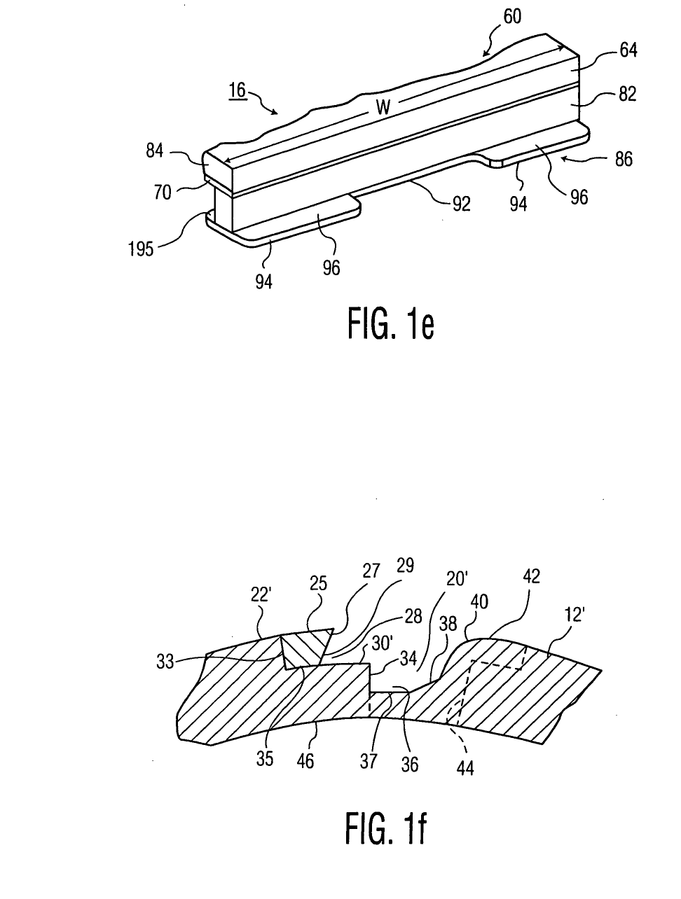

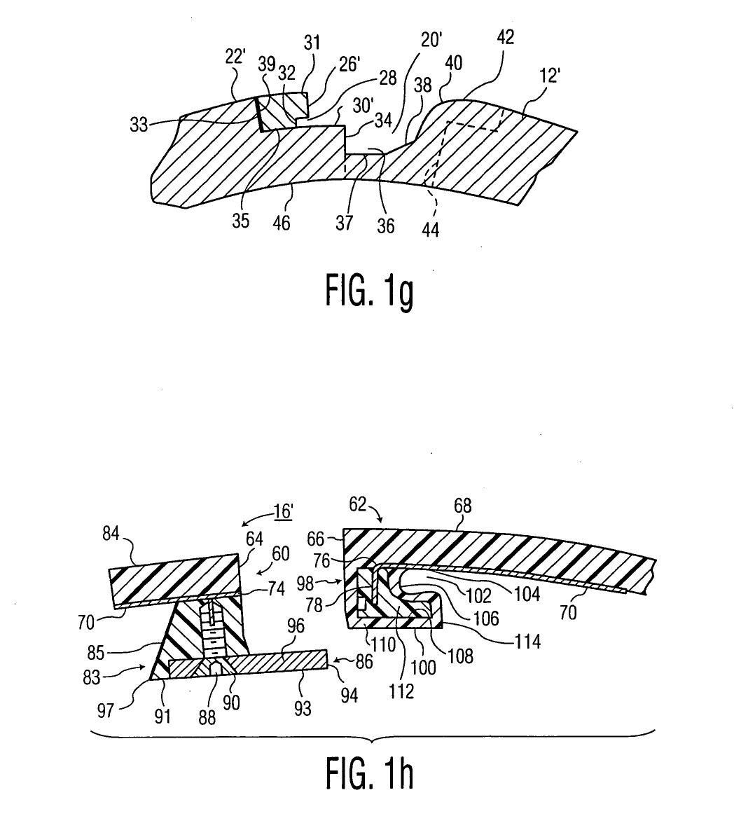

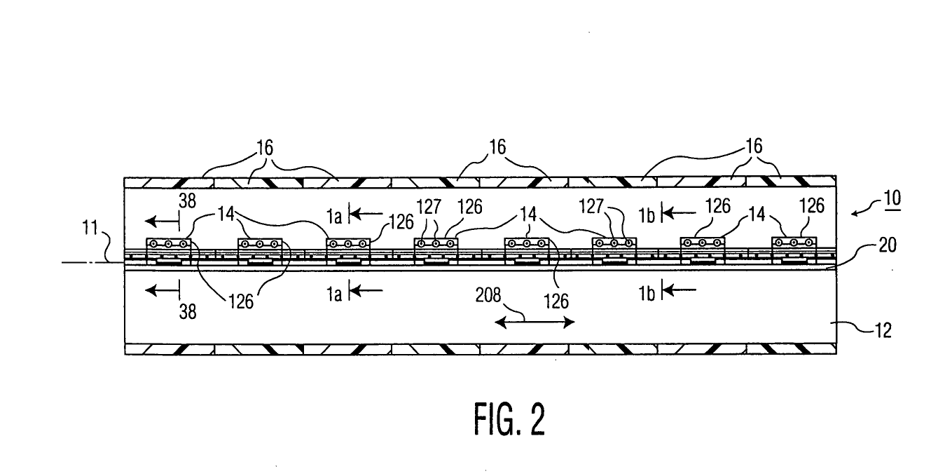

In FIGS. 1 and 2, die cutter anvil and locking apparatus assembly 10 in one embodiment of the present invention comprises a steel circular cylindrical anvil 12 having a longitudinal axis 11 and an axial array of identical pneumatically operated blanket securing apparatuses 14, each apparatus for securing a corresponding single die cutter blanket, FIG. 2. Such a series arrangement of blankets is also shown for example in U.S. Pat. No. 6,612,214 ('214) incorporated by reference in its entirety herein. Each blanket 16 is preferably secured to the anvil 12 by an individual apparatus 14 (in a manner not shown in FIGS. 1 and 2). In FIG. 2, in a preferred embodiment, an array of a plurality of eight apparatuses 16 are used to secure a corresponding array of eight blankets 16. Each of blankets 16 abuts an adjacent blanket 16 on the anvil 12. The blankets 16 are secured to the anvil in a manner to form a continuous smooth outer die cutting surface without interruption or deviation from a true circular cylinder when locked in place to the anvil by the blanket locking apparatuses 14.

In the figures, parts with the same reference numeral are identical and parts with the same reference numeral, but with a prime are similar.

In the alternative, in assembly 20, FIG. 5, a pair of apparatuses 14 are installed on a relatively short anvil 18 compared to the anvil 12 of FIG. 2 and sized to received two adjacent abutting blankets 16. The apparatuses 14 cooperate to secure the blankets 16 to the anvils 12 (FIGS. 1 and 2) or anvil 18 (FIG. 5) simultaneously.

The assembly 10, FIG. 1, is used in a corresponding die cutting system (not shown) in which dies cut sheet material such as paperboard, e.g., a web of cardboard blank sheet material, moving in a plane over the rotating anvil 12 (or anvil 18) and blankets 14. In a die cutting process, blank sheet material such as cardboard and the like is die cut by rotating cutting dies (not shown) as the sheet material is conveyed in a plane over the rotating blanket.

The anvil 12, FIGS. 1 and 1c, formed of steel, has an axially extending channel 20 formed in communication with outer circular cylindrical surface 22. The channel 20, FIG. 1b, is of complex cross section and extends for the length of the anvil 12 parallel to the anvil rotation axis 11. The channel 20 is periodically interrupted along its length by a differently shaped channel 24, FIGS. 1a and 1c, which channels have some common structure to be described. The channels 20 and 24 are shaped to receive an apparatus 14, FIGS. 1 and 2, in a manner to be described below.

The channel 20, FIGS. 1b and 1c, in anvil 12, has a side wall 26 which is normal to surface 22. The wall 26 terminates spaced from surface 22 at blanket locking groove 28 which is rectangular in cross section as shown. The groove 28 extends into wall 26 juxtaposed with the surface 22. The wall 26 and groove 28 extend along the channels 20 and 24, FIGS. 1a, 1b, and 1c, parallel to the anvil axis 11, FIGS. 1, 1c and 2 for the length of the anvil. The groove 28 has a planar bottom wall 30 that is normal to side wall 26 and normal to the interior end wall 32 of the groove 28. The bottom wall 30 is generally parallel to the outer surface 22.

In FIGS. 1a, 1 b and 1c, bottom wall 30 terminates interior the channel 20 at and normal to planar side wall 34. Wall 34 forms a side wall of a secondary channel 36 that forms a portion of channel 20 and that is more radially within channel 20 relative to the anvil outer surface 22. Channel 36 has a bottom wall 37 and an inclined side wall 38 opposite wall 34 and extends along the anvil axis 11 (FIG. 1). Inclined side wall 38 terminates at channel 20 side wall 40 which is on the opposite side of channel 20 from side walls 26 and 34. Side wall 40 is convex and is a segment of a circular cylinder. The wall 40 terminates at one edge thereof generally parallel to the side wall 34 at the wall 40 junction with inclined side wall 38 interior of the channel 20. The other edge of wall 40 opposite the wall 38 merges coplanar with the outer surface 22 of the anvil 12 forming a smooth transition therewith at junction 42. Thus wall 40 forms an arcuate side wall of channel 20.

Channel 24, FIGS. 1a and 1c, is in communication with a rectangular opening 42 through the anvil 12 from outer surface 22 to inner surface 44. The opening 44 has two opposite side walls 48, 50 which are at right angles to wall 34, which forms a side wall thereof as well. The opening 44 has a fourth side wall 52. All of the side walls are planar. A rectangular recess 54 is defined by a planar bottom wall 56 and a rear wall 58 normal thereto and which terminates at surface 22 normal thereto. Wall 56 forms a shoulder region in the channel 24 recessed relative to arcuate surface 40. An apparatus 14 is attached to the anvil 12 in the channel 24 and in portions of channel 20 on opposite sides of the channel 24 as will be described below.

Representative blanket 16, FIG. 1d, has identical end portions, male end portion 60 and female end portion 62, as all of the other blankets 16 of the array of blankets on anvil 12, FIG. 2. The blanket 16 preferably is polyurethane plastic (thermoset plastic) molded sheet material that terminates at two end edges 64 and 66 at respective female and male ends 60 and 62. The blanket 16 has an outer work surface 68. The surface 68 is continuous, smooth and circular cylindrical when the blanket 16 is wrapped about the anvil 12, FIG. 2, with the end edges 64 and 66 abutting as shown in FIG. 13. The surface 68 thus presents no discontinuities or changes in surface conditions such as intermittent flat and cylindrical regions or gaps or openings in the surface, and exhibits substantially uniform hardness to the cutting blades which impact thereon. These properties ensure substantially uniform die cutting of paperboard blanks in use with the die cutting blades (not shown).

A preferably steel sheet metal liner 70 is molded or otherwise bonded or attached to the bottom surface 72 of the blanket for substantially the entire length of the blanket (directions 74). The liner 70 has a female edge 74 that terminates at blanket edge 64. The liner 70 has a male edge 76 that terminates spaced somewhat from the male edge 66. The liner 70 male end at edge 76 has a right angle bend forming a depending leg 78. The liner 70 has a female leg 80 depending from and attached to the male end 60 of the liner 70. The steel liner frictional engagement with the anvil prevents axial shifting of the blanket 16 during the die cutting process.

An elongated rectangular, or in the alternative, square, in cross section projection 82 molded of the same material as the blanket 16 depends from the blanket sheet material 84 region at end portion 60, FIGS. 1d and 1e. The projection 82 extends normal to the drawing sheet into and out of the drawing, FIG. 1d, for the width of the blanket 16 in these directions as shown in FIG. 1e by the dimension w. The projection 82 may be the same material as blanket 16 sheet material 84 or different. The projection 82 may be molded to the sheet material 84 through apertures (not shown) in the liner 70 or bonded by an adhesive (not shown).

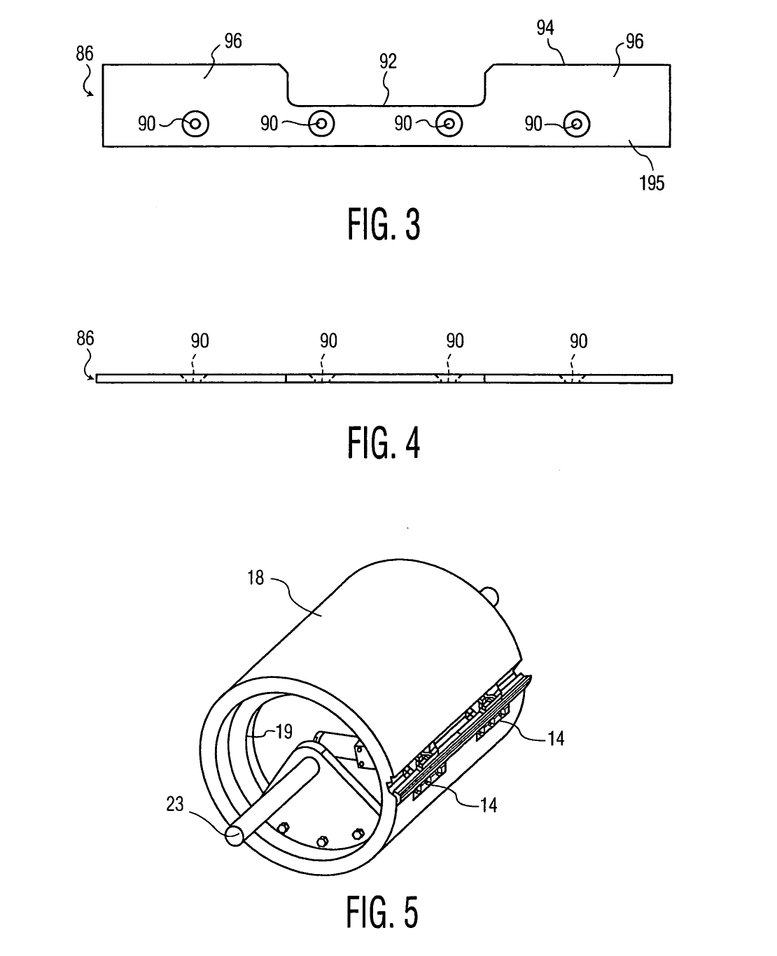

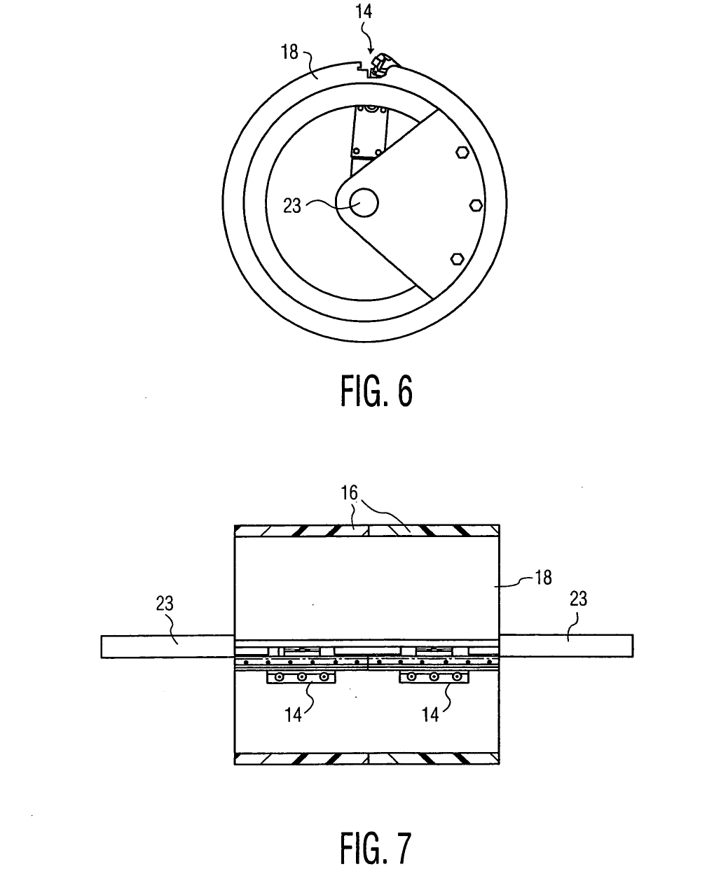

In FIGS. 1d, 3 and 4, a locking plate 86 is screwed to the bottom surface of projection 82 by screws 88 (FIG. 1d). The screws 88 are threaded into mating bores 89 in the projection 82. The plate 86, FIGS. 3 and 4, is sheet steel and has an array of counter sunk apertures 90. The plate 86 has a recess 92 in its forward edge 94, FIG. 3, forming the forward edge 94 into two sections 96 which extend beyond the blanket female end edge 64. The recess 92 accommodates portions of the apparatus 14 to be described below. The screws 89 abut an edge of the depending liner leg 80, FIG. 1d. This makes the blanket material 84 more rigid in this region to provide uniform pressure response to the die cutting blades that impinge on the blanket surface 22 overlying the projection 82 which pressure response might not otherwise occur.

The male blanket end portion 62, FIG. 1d, has a male projection 98 depending from the blanket sheet material 84. The projection is of the same material as the blanket material 84 and has its edge 66 normal to the blanket surface 22 and which mates and abuts the edge 64 of the female end 60 which edge includes that of the liner 70 and projection 82 which are coplanar and normal to the surface 22. The projection 98 has a planar bottom surface 100 which is juxtaposed with the end region of surface 22 extending in a direction away from projection 82 when abutting (FIG. 13). The surface 100 abuts and rests on the forward sections 96 of the locking plate 86 in the final use position of the blanket 16 as shown in FIG. 13. At this time the end surfaces of the blanket edges 64 and 66 also abut.

The projection 98 has a recess 102 that faces in a circumferential direction away from the projection 82 in the channel engaged position of the projections 82 and 98 in the blanket-anvil locked position of FIG. 13. One side 104 of the recess 102 is formed by a surface of the liner 70. The innermost end 106 of the recess 102 is arcuate and somewhat cylindrical. The projection 98 has a hollow core 108 formed by an outer wall 110. The liner leg 78 extends into the hollow core 108. A plastic material insert 112 is molded inside the core 108 into which the liner leg 78 is molded. The insert 112 increases the hardness of the blanket at the male end region 62 that might otherwise be softer due to the presence of the projection 98 in this region. See commonly owned U.S. Pat. No. 6,668,694 filed in the name of the present inventor. The projection 98 has an innermost wall 114 that is aligned with the edge 94 of the locking plate 86 when in the blanket-anvil locked position of FIG. 13.

In FIG. 1g, in an alternative embodiment, anvil 12′ has a rectangular recess 39 in the anvil outer surface 22′. The recess 39 is formed by horizontal wall 30′, and wall portion 35, which walls are similar to wall 30, FIG. 1b, and vertical wall 33, which is normal to the anvil outer surface 22′. An elongated steel strip 31 is L-shaped and is removably attached (by screws not shown) to the anvil wall 30′ in recess 39, abutting the horizontal wall 35 and the vertical wall 33. The strip has a vertical wall 26′ forming a wall of channel 20 (corresponding to wall 26, FIG. 1b). Recess 28, which is identical to recess 28, FIG. 1b, is formed by an elongated L-shaped notch in the strip 31. The recess 28 is also formed by anvil walls 30′ and 35. The strip 31 thus is replaceable in case the recess 28 wears or the surfaces thereof become damaged due to repetitively insertion and removal of blankets. Thus a new undamaged recess 28 can easily be provided in such a situation with a new strip 31. Such wear or damage of the recess 28 could interfere with proper seating of the mating locking plate 86 lip 95 (FIG. 1d) of the mating female projection 82 of the blanket 16 and detrimentally affect the blanket operating performance.

In FIG. 1f, in a further alternative embodiment, anvil 12′ is identical to anvil 12′ of FIG. 1g. In this embodiment, the strip 31 of FIG. 1g is not used and is replaced with steel strip 25. Strip 25 is screwed to wall 30′ as described above for strip 31. Strip 25, however, differs in that the recess 28 is no longer provided. The strip 25 has a wall 27 that has a face that is inclined relative to the wall 30′. The inclination is at an angle such as to form an undercut acute angular recess 29 formed by the overlying wall 27 face and wall 30′. The recess 29 extends for the length of the strip 25, which extends for the width of the mating blanket 16′ (FIG. 1h). Except for the presence of the strip 25, FIG. 1f, or strip 31, FIG. 1g, the anvil 12′ is otherwise identical to the anvil 12 of FIGS. 1, 1a and 1b.

In FIG. 1h, blanket 16′ is for use with the anvil 12′ and strip 25 of FIG. 1f. Reference numerals in FIG. 1h identical to reference numerals in others of the figures such as FIG. 1d, represent identical parts. Except for the female projection 83, FIG. 1h, the rest of the blanket 16′ is identical to blanket 16, FIG. 1d. The female projection 83 replaces the female projection 82, FIG. 1d. The locking plate 86 is also identical in FIGS. 1d and 1h.

The difference is in the configuration of the projection 83 which is molded plastic material and molded attached to the liner 70 of the blanket as is projection 82. The projection 83 has a rear wall 85 that is inclined at the same angle as the bottom surface of the attached locking plate 86 as the angle of wall 27 of the strip 25, FIG. 1f. The wall 85 abuts the wall 27 and fits in the recess 29 formed by the strip 25 and wall 30′, FIG. 1f. The recess 29 is complementary to the wall 85 and the bottom wall 91 of the projection 83, the latter wall being coplanar with the bottom wall 93 of the locking plate 86. Walls 91 and 93 abut the wall 30′. Walls 85, 91 and 93 form a wedge shaped portion 97 of the projection 83. Portion 97 mates with and is complementary to the wedge shaped recess 29 formed by the strip 25 and wall 30′, FIG. 1f, of the anvil 12′. The recess 29 and mating wedge shaped portion 27 are significantly larger in cross section area than recess 28, of the embodiment of FIG. 1b and mating locking plate 86 lip 95, FIG. 1d. As a result the arrangement of FIGS. 1f and 1h directed to the wedge shapes is more forgiving than the small cross sectional areas of the lip 95 and recess 28, and is expected to have a longer useful life in practice. That is damage to the wedge shape portion 97 of the blanket projection 83 and mating recess 29 during use is believed to be less than the embodiment of recess 28 and lip 95 and thus have a lower impact on the life of the blanket. The embodiment of FIGS. 1f and 1h thus are most preferred.

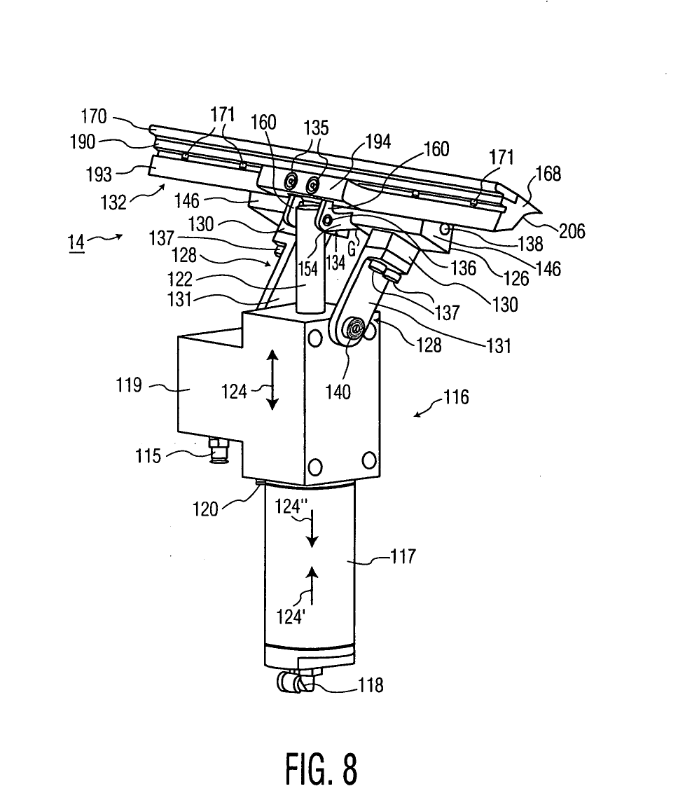

In FIGS. 8, 9 and 11, blanket locking apparatus 14 comprises an actuator, air cylinder assembly 116. Assembly 116 comprises a primary air cylinder 117 and a secondary locking cylinder 119. The primary cylinder 117 operates piston shaft 122 in reciprocating directions 124 in response to applied pressurized air. This action of the shaft locks and unlocks the blanket 16 to the anvil 12 (FIG. 2)

In FIG. 11, The locking cylinder 119 has a locking piston 121. The locking piston 121 reciprocates in directions 125 normal to the directions 124. The piston 121 has a locking friction tip 123 which frictionally engages the shaft 122 and locks shaft 122 in its position when engaged therewith. A spring 111 is in the locking cylinder 119 chamber and normally biases the locking piston 121 to the locked state engaged with shaft 122 of the air cylinder 117, direction 125″. The piston 121 resiliently urged against the shaft 122 provides a 310 lb. (141 Kg) locking shaft axial holding force on the shaft 122 to lock the shaft 122 in position without any pressurized air present in air cylinder 117 or cylinder 119. The cylinder assembly 116 is commercially available from the Bimba Corp. as its 31 series of air operated cylinders.

The cylinder assembly 116 has air inlet/exhaust ports 118, 119 and 120. Port 118 receives supply pressurized air, e.g., 80 to 90 psig, to raise the locking bar assembly to the blanket unlocked state by extending the shaft 122 in direction 124′. At this time, pressurized air, e.g., 80 to 90 psig, is also supplied to port 115 of the locking piston cylinder to release the locking piston from the spring urged locked engagement with the piston shaft 122 of cylinder 117, retraction direction 125′.

Port 120 receives pressurized air at double the pressure of ports 118, 119, e.g., 160 to 180 psig, to retract (lower) the shaft 122 in direction 124″ to lock the blanket 16 to the anvil 12. After this, the pressurized air at port 115 is released. The locking piston 121 tip 123, biased by the spring 111, is forced to engage the retracted shaft 122 of the primary cylinder 117 in the blanket 16 male end lowered locked state. The tip 123 thus locks the shaft 122 in the lower retracted blanket locked state without any pressurized air being applied to the cylinders 117 and 119.

The apparatus 14 includes a mounting base 126 for mounting the actuator air cylinder assembly 116. The mounting base 126 is screwed by screws 127, (FIGS. 1 and 2) to the anvil 12. The actuator air cylinder assembly 116 is pivotally attached to the mounting base 126 by a pair of spaced identical mounting brackets 128 mounted in mirror image fashion via a standoff block 130 secured between each cylinder mounting bracket 128 and the mounting base 126.

The bracket 128, FIG. 10, is an L-shaped member having legs 131 and 133. The leg 131 has a pivot journal through bore 139. Bore 139 receives pivot trunion 140, FIG. 11, which trunion pivotally secures the actuator air cylinder assembly 116 to a bracket 128. A trunion 140 is on each side of the actuator air cylinder assembly 116 in a corresponding threaded bore to which the trunion is attached. The leg 133 has a pair of through bores 141 which receive screws 137 (FIGS. 8, 9 and 11). A pair of screws 137 secure each of the brackets 128 to the mounting base 126 via threaded bores 150 in the mounting base 126. The screws 137 pass through mating holes in the intermediate standoff block 130 between a bracket 128 and the mounting base 126 to secure the block between a bracket 128 and the mounting base 126.

A locking bar assembly 132 is rotatably secured to the end of the cylinder shaft 122 by a link 134. The locking bar assembly 132 is securely fixed to one end of a link 134 by two cap screws 135. Link 134 is pivotally pinned to shaft 122 by pivot trunion 136 and is pivotally secured to mounting base 126 by pivot pin 138. The actuator air cylinder assembly 116 is pivotally secured to the mounting brackets 128. Pivot trunions 140 which pass through bores 139 (FIG. 10) of the mounting brackets 128 and into a corresponding threaded bore (not shown) in the body of the actuator air cylinder assembly 116 (FIGS. 8, 9 and 11).

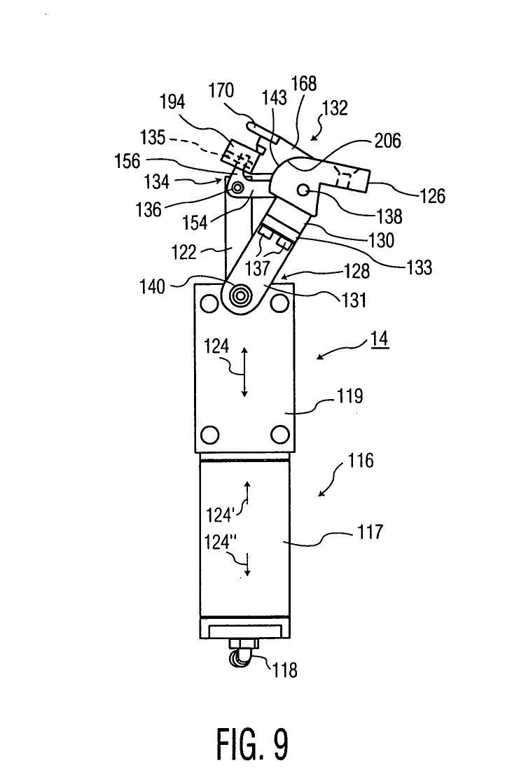

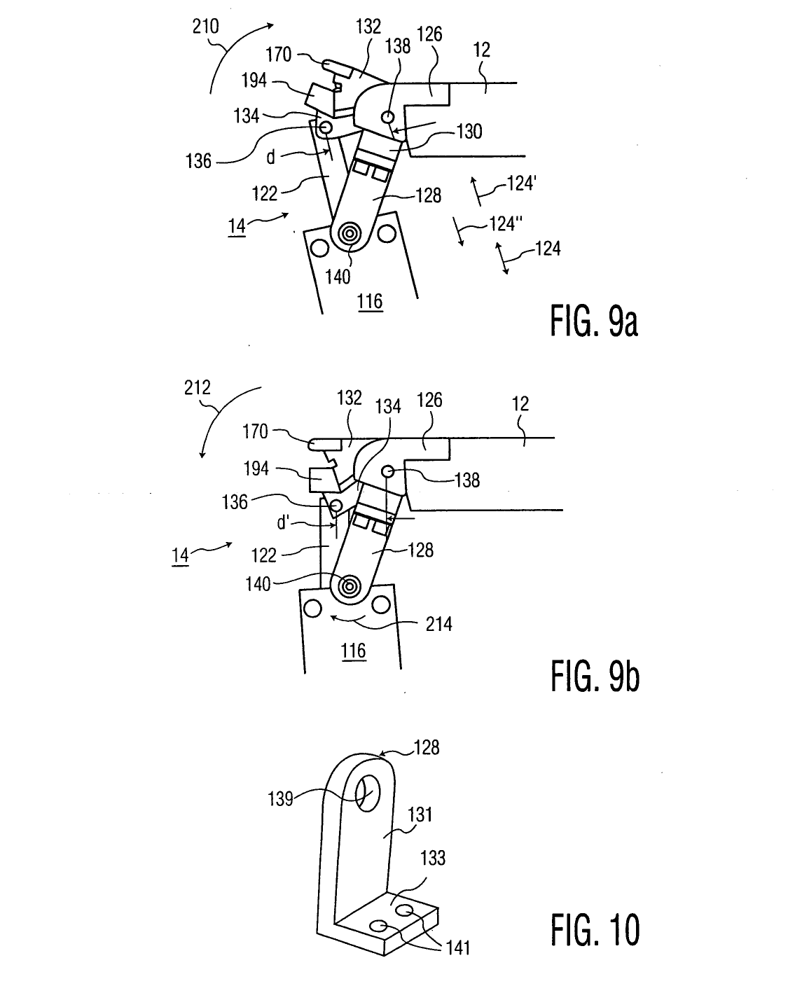

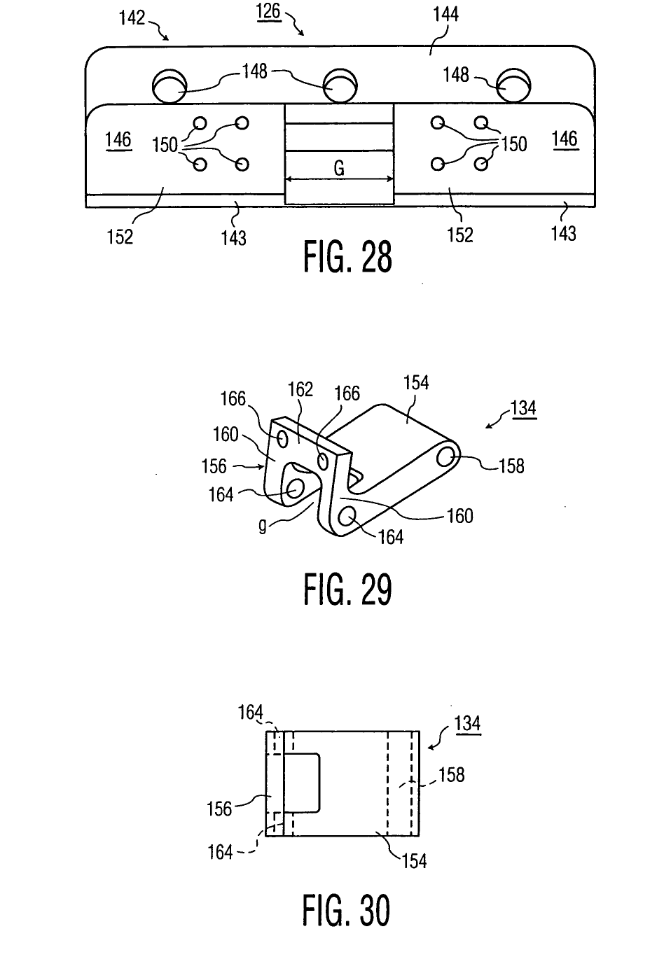

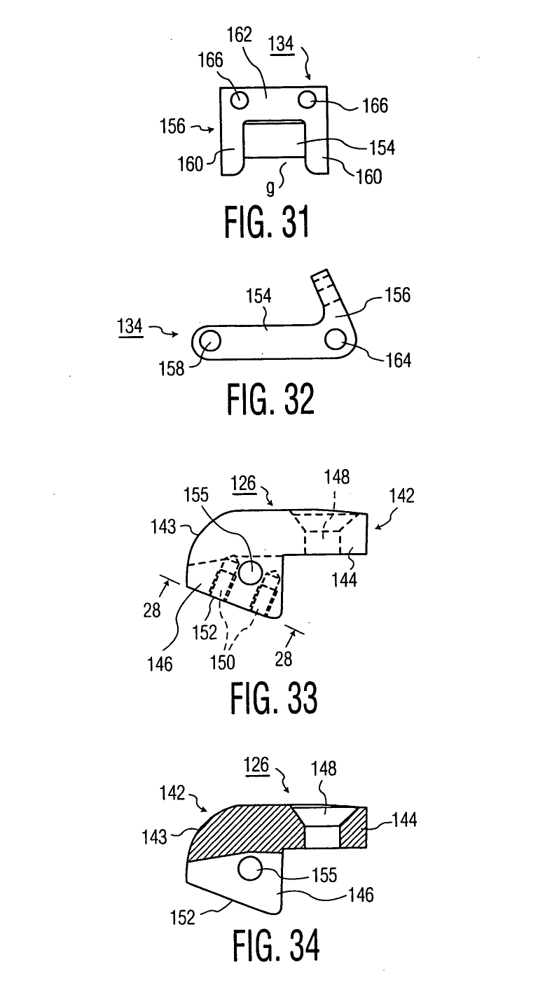

In FIGS. 26-28 and 33-34, air cylinder mounting base 126 comprises an L-shaped body 142 having a leg 144 at a right angle to a pair of identical spaced aligned coplanar legs 146. Leg 144 is rectangular and has three countersunk mounting holes 148 for receiving the mounting screws 127 (FIGS. 1 and 2), which screws attach the base 126 to the anvil 12. The screws 127 attach the leg 144 (not shown in FIG. 1a) to the anvil 12 via bores 59 (FIG. 1a) in the anvil recess 54. The legs 146 are spaced apart by gap G, which receives the link 134 leg 156 (FIGS. 29-32). Each leg 146 has an array of four tapped holes 150 for receiving mounting screws 137 (FIGS. 8, 9 and 11). The screws 137 secure the leg 133 of the bracket 128, FIG. 10, to the block 130 and both to the mounting base 126. The legs 146 have a bottom surface 152, FIGS. 33 and 34, which is inclined to a line that is perpendicular to the leg 144. A pivot journal bore 155 is in each leg 146 and passes through the legs 146. The bores 15 are aligned with each other for receiving the pivot pin 138 (FIGS. 8 and 9). The mounting base 126 outer surface 143 at the interface of legs 144 and 146 is arcuate and preferably a portion of a circular cylinder, as best seen in FIGS. 33 and 34. Surface 143 terminates at bottom surface 152 of the leg 146.

Link 134, FIGS. 29-32, has two legs 154 and 156. Leg 156 is U-shaped having like spaced leg portions 160. Leg 56 has a connecting link portion 162 which connects the two leg portions 160. The leg portions 160 form a gap g which receives the air cylinder piston shaft 122 (FIGS. 8, 9 and 11). The leg 154 has a journal bore 158 which receives pivot pin 138. Pin 138 passes through the bores 155 in the legs 146 of the mounting base 126, FIGS. 33, 34, 8 and 9. The two leg portions 160 at their junction with leg 154 have axially aligned bores 164, which bores receive pivot trunion 136 which is rotatably journaled in the piston shaft 112. The pivot trunion 136 rotatably secures the link 134 to the air cylinder piston shaft 122. As a result of this pivoting action, the link legs 154 and 156 rotate relative to the piston shaft 122.

The leg 154 is located in the gap G of the mounting base 126, FIGS. 8, 11, 28, and 29. The leg 156 has two through mounting bores 166. Bores 166 receive mounting cap screws 135, FIGS. 8, 9 and 11, and secure the leg 156 of the link 134 to the locking bar assembly 132.

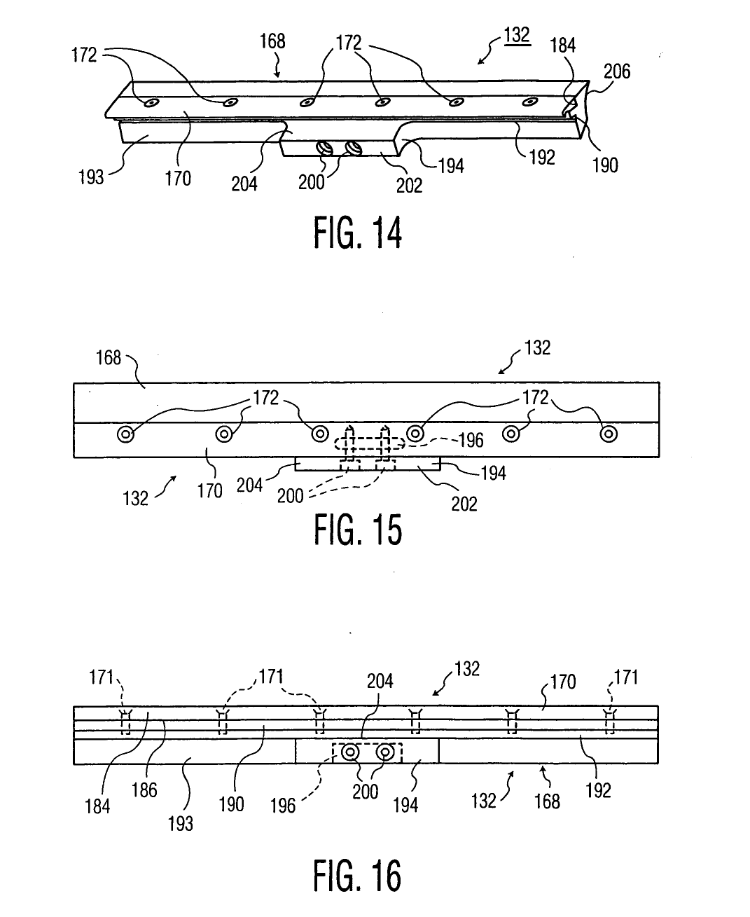

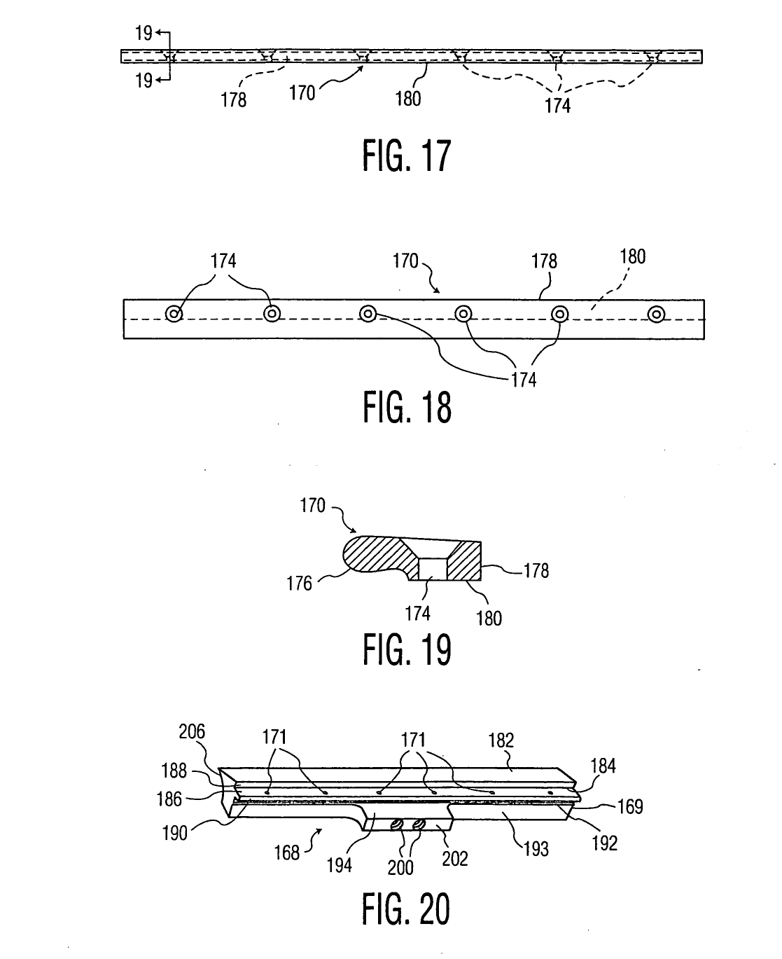

In FIGS. 14-16, the locking bar assembly 132 is shown to comprise a locking bar 168 and a nose piece 170. The nose piece 170, made of steel, is secured to the locking bar 168 by screws 172 via threaded screw holes 171 in the locking bar 168. In FIG. 18, the nose piece 170 is an elongate metal strip, preferably steel or aluminum, that has an array of counter sunk bores 174 which receive screws 172. In FIG. 19, the nose piece 170 has an arcuate nose 176 which is approximately semicylindrical in cross section. The nose 176 fits in the complementary shaped recess 102 in the male projection 98, FIG. 1d, and are in mated relationship with each other, FIG. 13. The nose piece 170 has an end wall 178 that is normal to bottom wall 180.

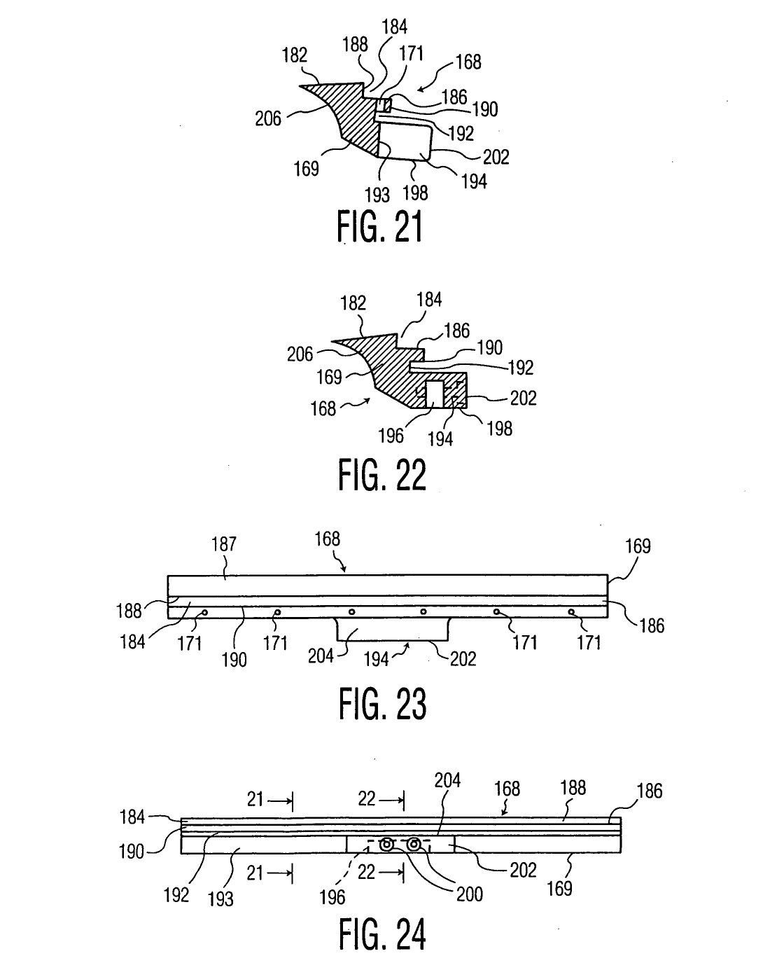

In FIGS. 20-25, locking bar 168 is an elongated, preferably steel or aluminum, body 169. The bar 168 has a planar top surface 182 that terminates at rectangular recess 184. Recess 184 has a bottom planar wall 186 and an upwardly extending planar rear wall 188. The wall 186 is partially formed by a rectangular rib 190 formed by slot 192. The array of threaded bores 171 are in bottom wall 186 and pass through the rib 190 in communication with the slot 192, FIG. 21. The nose piece 170 mounts in recess 184 and is secured to the wall 186 (and to the rib 192) by screws 172 (FIG. 15).

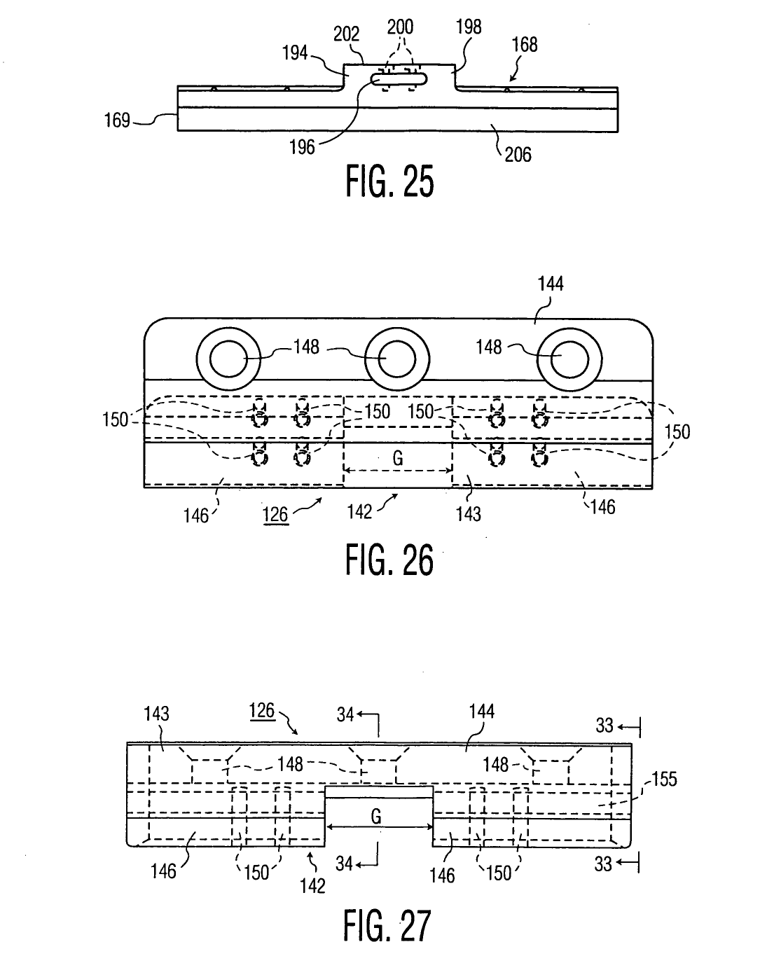

The body 169 has a planar front wall 193. A rectangular mounting boss 194 extends from the front wall 193. The boss 194, FIGS. 22 and 25, has an elongated slot 196 extending partially into the boss 194 and in communication with the bottom wall 198 of the boss 194. A pair of spaced counter sunk bores 200 are in the front wall 202 of the boss 194 in communication with the slot 196. The top wall 204 of the boss 194 is coextensive with the slot 192.

The body 169 has an arcuate concave surface 206. This surface 206 is complementary to the convex arcuate surface 143, FIGS. 33 and 34, of the mounting base 126 and of the curved convex arcuate surface 40 of the anvil 12, FIG. 1b.

In assembly of the locking apparatus 14 to the anvil 12, the mounting base 126, FIGS. 8, 9 and 11, is secured in the recess 54, FIG. 1c, of the anvil 12 by screws 127 (FIG. 2) attached to the threaded bores 59 in the recess. The concave arcuate surface 206 of the locking bar assembly 132 mates with and rotatably slides over the convex arcuate surface 143 of the mounting base 126, as best seen in FIGS. 9 and the convex arcuate surface 40, FIG. 1a, of the anvil 12. The locking bar 168 of assembly 132 has a length that matches the width of a blanket 16, all of which are identical. The locking bar length is also greater than that of the recess 54 (FIG. 1c) of the anvil 12 and greater than the length of the mounting base 126 in the axial direction of the anvil, left to right, FIGS. 26-28, directions 208, FIGS. 1 and 2. As a result, the locking bar 168 arcuate concave surface 206 abuts and mates with the convex arcuate corner surface 40, FIG. 1a, of the channel 24 of the anvil 12 beyond each of the mounting base ends. The locking bar surface 206 rotatably slides on the anvil arcuate surface 40 in response to the actuation of the actuator, air cylinder assembly 116, FIGS. 8, 9 and 11. The locking bars 168 abut one another along the anvil 12 channel 20, FIGS. 1, 1a and 2.

In FIG. 29, the leg 156 of link 134 is inserted into the boss 194 slot 196, FIG. 25, as best seen in FIG. 11. The link bores 166 in leg 156 are aligned with the bores 200 in the locking bar 168, FIG. 14. The cap screws 135 (FIG. 11) are engaged with the link bores 166 in the leg 156 and the boss bores 200 of the locking bar 168 to fixedly secure the leg 156 of the link 134 to the locking bar boss.194.

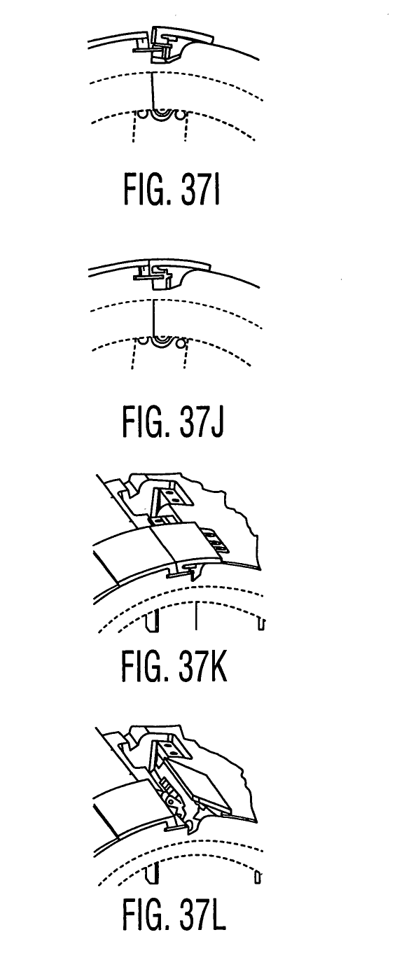

In operation of the locking bar assembly 132, FIGS. 8, 9 and 11, the actuator air cylinder assembly 116, being attached to the mounting base via brackets 128 and blocks 130 as described above, is free to rotate about the pivot trunions 140. In FIG. 9a, the air cylinder shaft 122 is shown extended in direction 124″. The extended shaft 122, being pivotally attached to link 134 by trunion 136, raises the link 134 in direction 124″ relative to the anvil 12 and to mounting base 126 as the shaft 122 rotates relative to trunion 136. The raised link 134 is in the blanket unlocked position where the blanket 16, if previously secured to the locking bar nose, is in a position to be released. If not attached to the nose previously, the blanket recess 102 in male projection 98 can now be manually attached to the locking nose 176 (See FIGS. 37G and 43) of the locking bar.

The link leg 154 is rotatably pinned to the mounting base 126 by pin 138, FIG. 9. When the shaft 122 is extended (raised radially relative to the anvil 12) in direction 124′, the link 134 and locking bar assembly 132 are rotated about pin 138 in direction 210. In this position, the pin 138 is spaced from trunion 140 a distance d that is in a direction that is normal to the shaft 122.

In FIG. 9b, the shaft 122 is shown in the retracted lowered locked state, direction 124″, of the apparatus 14 (normally with a blanket attached as shown in FIG. 13). This action rotates the link 134 in direction 212. The distance d′ between the pin 138 and trunions 140 in a direction normal to the shaft 122 is reduced from distance d. At the same time, the actuator air cylinder assembly 116 is rotated about trunion 140. As a result, the link 134, the shaft 122 and actuator air cylinder assembly 116 and brackets 128 form a three bar linkage which are rotatably connected. One bar of the three bar linkage formed by the air cylinder and piston shaft 122 changes in length by retraction or extension of the shaft. This action causes rotation of the link 134 and of the air cylinder assembly 116. The locking bar arcuate surface is engaged with the mounting bar and the anvil corner arcuate surfaces. The locking bar rotationally rides on these arcuate surfaces as the link 134 and locking bar secured thereto are rotated. This action provides a positive high force on the locking bar nose 170 as it pulls the attached blanket 16, male end, FIG. 13, to the locked state shown.

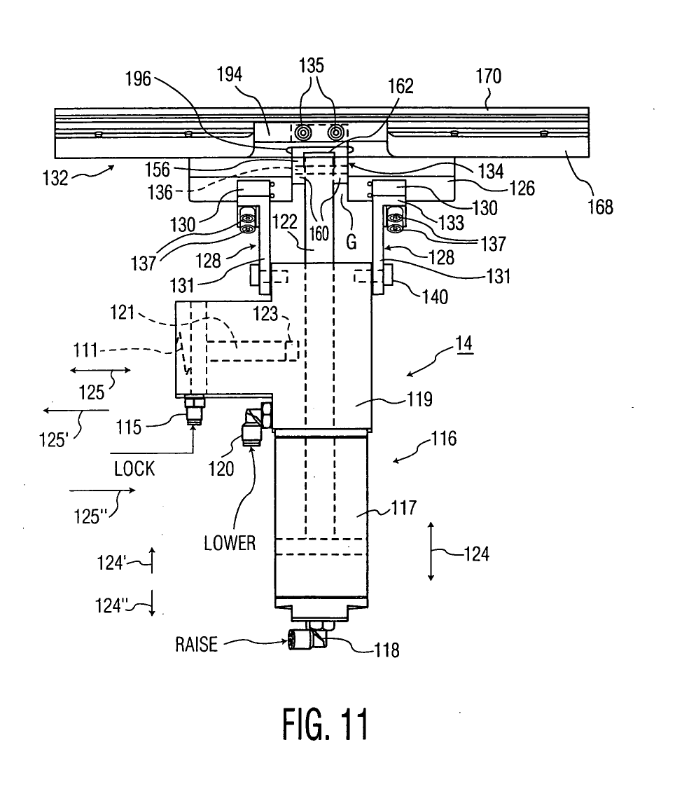

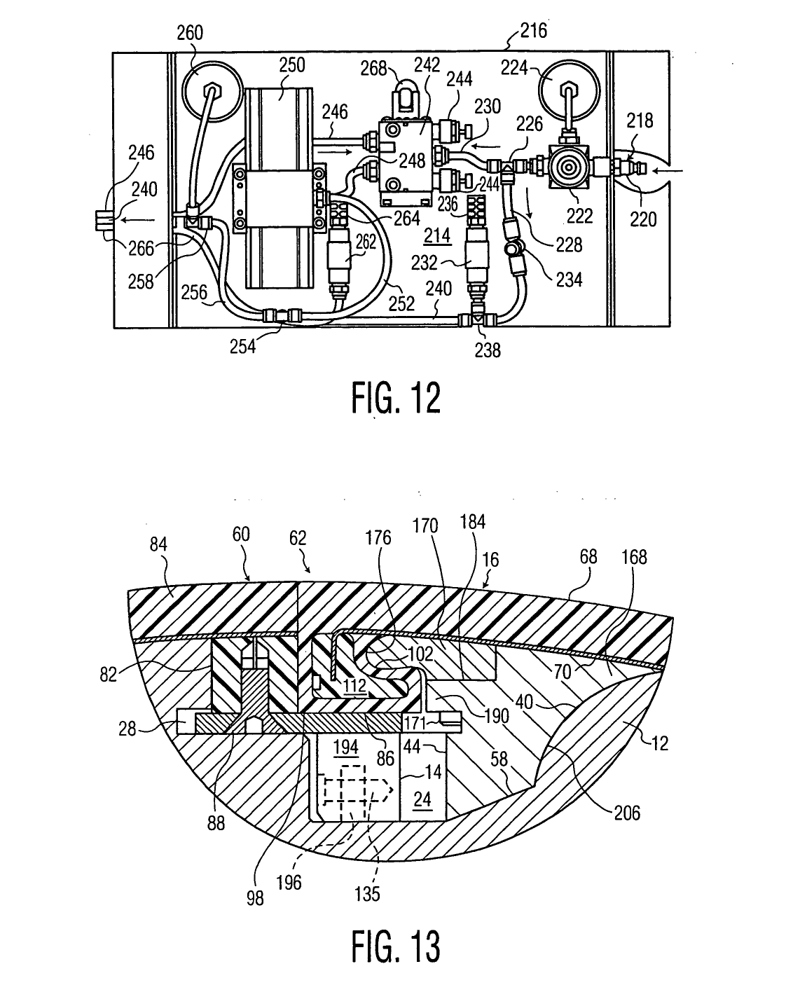

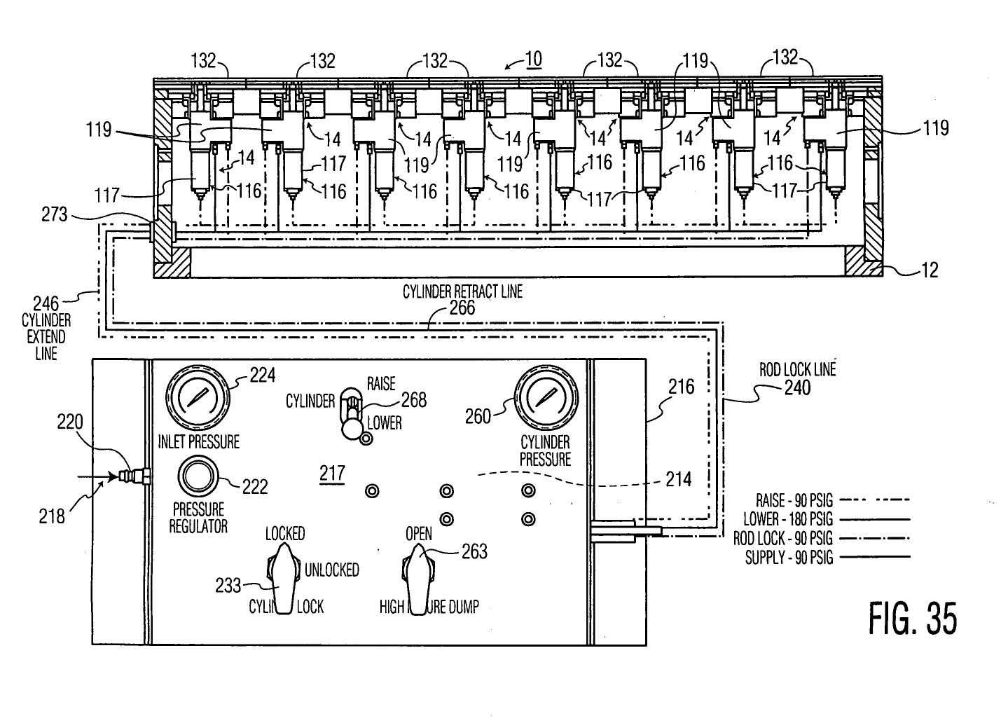

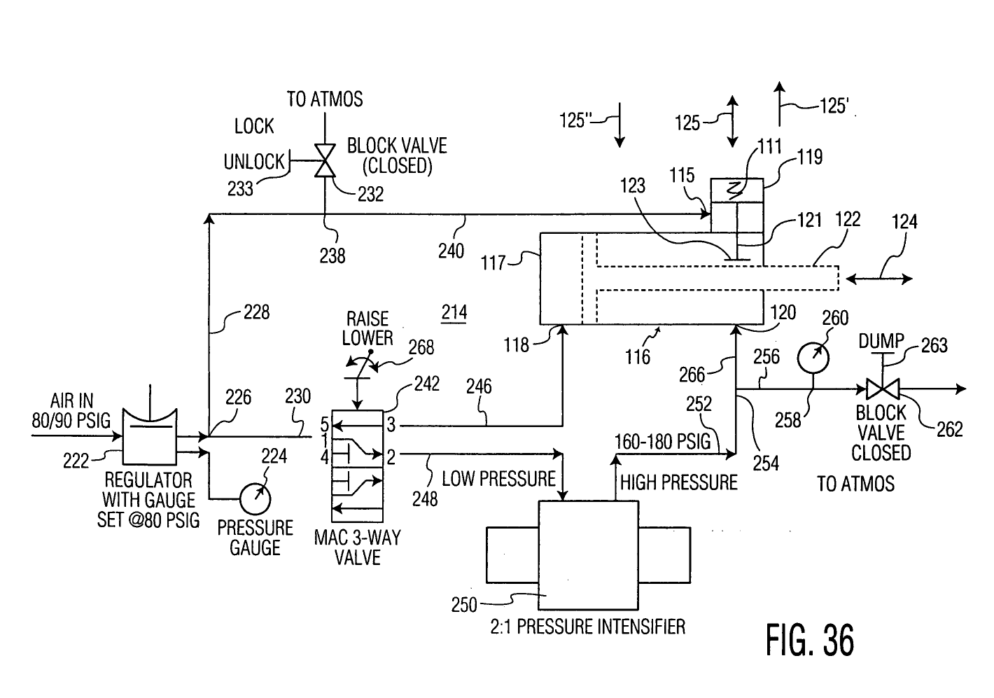

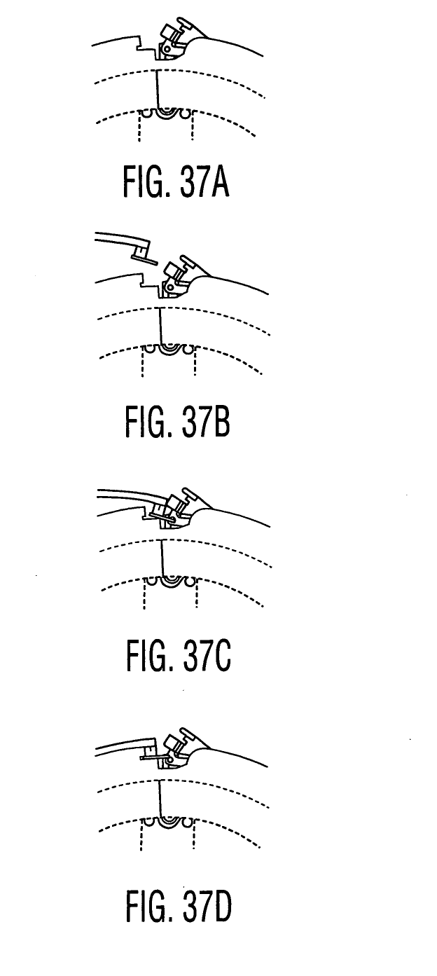

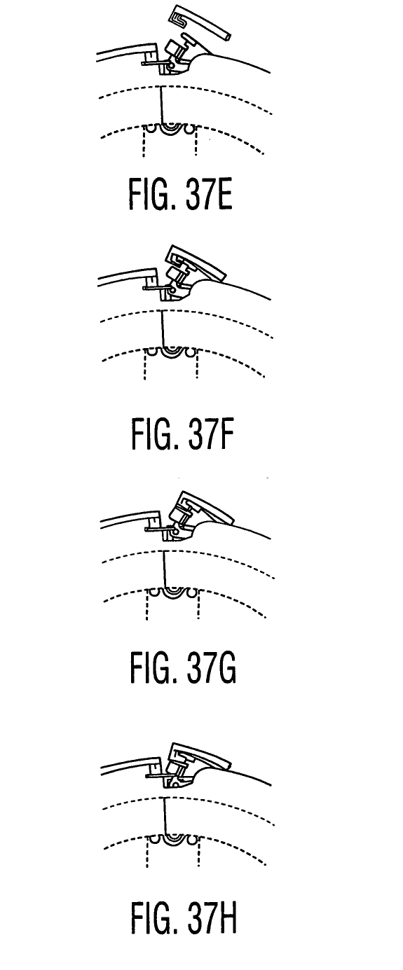

In FIGS. 12 and 36, pressurized air source air line circuit 214 is contained in a housing 216, FIG. 12, and schematically shown in FIG. 36. The circuit 214 has an inlet 218 at quick connect-disconnect fitting 220 which receives pressurized air at a pressure in the range of 80-90 psig. Fitting 220 is coupled to a pressure regulator 222 (80 psig). The pressure at regulator 222 is measured by gauge 224. The regulator output is supplied to a tee connector 226. The output of connector 226 is connected to lines 228 and 230. Line 228 is coupled to ball valve 232 through a flow valve 234 and tee connector 238. The ball valve 232 is in communication with the atmosphere through an SMC (muffler) silencer 236. The ball valve 232 is operated by knob 233, FIGS. 35 and 36, to operate the locking piston 121, FIG. 11.

The knob 233 either opens or closes the valve 232. When the knob 233 is rotated to the unlock state, FIG. 35, the valve 232 is closed. This valve closure applies pressurized air to the locking piston 121 to overcome the bias of spring 111 and unlocks the piston 121 by displacing the piston 121 in direction 125′, FIGS. 11 and 36. This action releases the primary air cylinder 117 piston shaft 122 so it can be raised to the unlock state in direction 124′.

The tee connector 238 is coupled to line 240 which is an output line of the circuit and supplied to the actuator air cylinder assembly 116. In particular, in FIG. 36, the line 240 is coupled to the port 115 fitting to supply 80-90 psig (36.3-40.85 Kg) air pressurized air to the locking cylinder 119 to release the locking piston 121 as described when the knob 233, FIG. 35, is rotated to the unlocked position. In the locked position, the knob is rotated to open the valve 232 which removes air pressure from the line 240. This permits the spring 111 to displace the locking piston 121 in the shaft 122 locking position direction 125″.

The other output line 230, FIG. 12, of connector 226 is supplied to a MAC 3 way valve 242. Two exhaust valves 244 are connected to the valve 242. The valve 242 has an output line 248, which is a low pressure line, e.g., 80-90 psig (36.3-40.85 kg). This pressurized air is supplied as an input to pressure doubler 250, which increases the incoming air pressure to 160-180 psig (72.6-81.7 Kg). The pressure doubler 250 has a high pressure ou supplied to tee connector 254. Tee connector 254 output line 256 is connected to tee connector 258. Connector 254 has a second high pressure output line 266 which supplies high pressure air to the cylinder assembly 116 port 120. Connector 258 has one output line connected to high pressure (160-180 psig, 72.6-81.7 Kg) gauge 260. A second output line of connector 258 is connected to ball valve 262 and to the atmosphere through SMC silencer 264. The ball valve 262 is operated by a rotating knob 263 (Fig. between open and closed states. In the closed state, it permits the high pressurize air to be applied to the 266 output of tee connector 258 and to port 120 of the air cylinder 117, FIGS. 11 and 36, to lower the piston shaft 122 to the locked stated, direction 124″. In the open state, the valve 262 dumps the high pressure air through the silencer 264 (FIG. 12) to the ambient atmosphere, removing the high pressure air from the cylinder 117. This action permits the cylinder 117 shaft 122 to be raised to the unlock state.

In the circuit 214, FIG. 36, the line 246 is low pressure 80-90 psig (36.3-40.85 kg). Line 246 is an output of 3 way valve 242 and which is connected to input port 118 of the air cylinder 117. The low pressure applied to port 118 is used to raise the cylinder 117 shaft 122 to the unlock state. The valve 242 is operated by toggle 268. In FIG. 35, the toggle is used to position the 3 way valve 242 to supply low pressure air to the pressure doubler 250 or to the cylinder 117 port 118, keeping in mind that the high pressure air at port 120 is used to lower the cylinder shaft 122 to the locked position and the low pressure port 118 is used to raise the shaft 122 to the unlocked position. Thus, the outputs of the circuit 214 of FIG. 35 appears on lines 240, 246 and 266 at the left side of the drawing figure and in FIG. 35 are on the right side of the housing 216.

FIG. 35 illustrates schematically the die cutter assembly of FIG. 1 with the air lines attached to the locking mechanisms 14 from the air pressure source circuit 214 contained in housing 216. This figure also illustrates the front face of a control panel 268 to operate the air line circuit 216. In this figure, the legend shows the connections of the low pressure, high pressure and locking air pressure is applied to the input ports of each air cylinder assembly 116 simultaneously from the air supply circuit 214 in the housing 216.

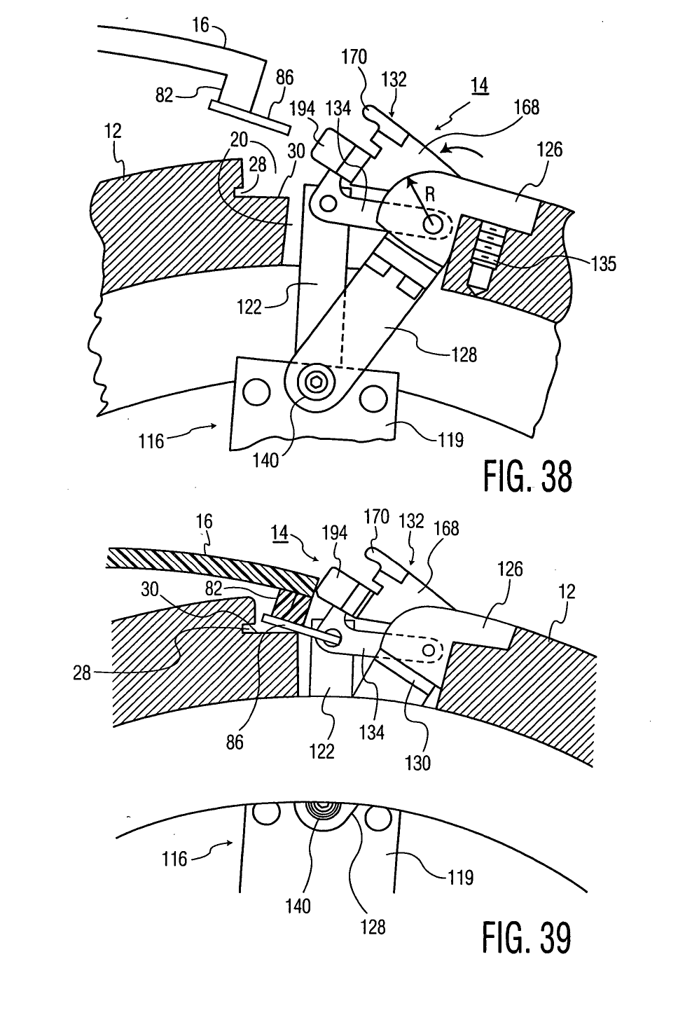

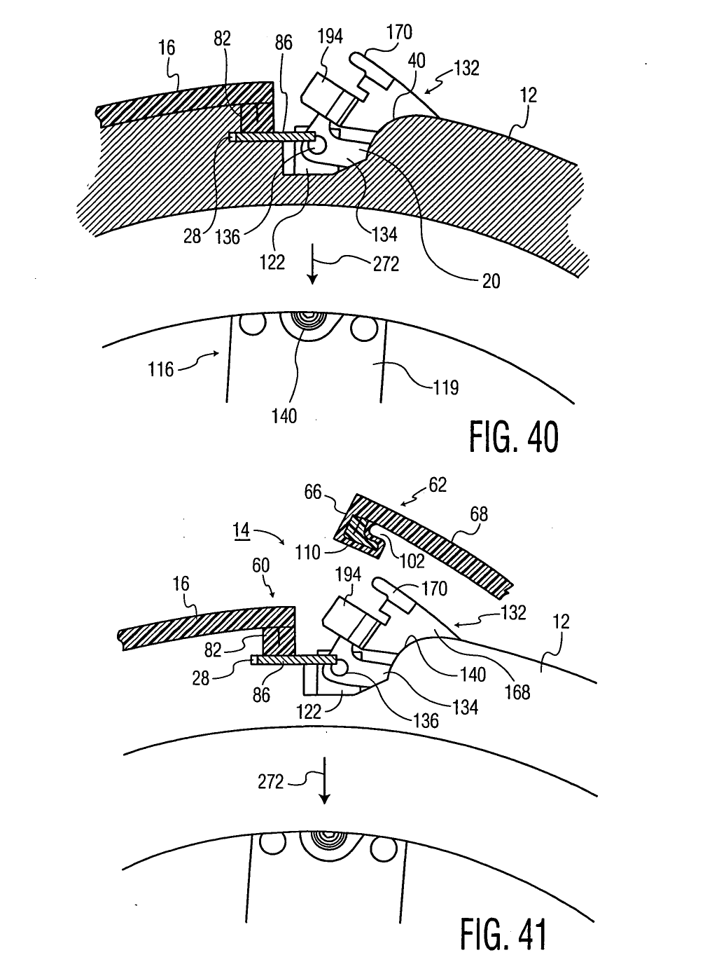

In operation, in the initial stage of the air cylinder assemblies, the shafts 122 thereof are in the raised position, FIG. 37, steps A and B, and in corresponding FIG. 38 which shows step B in more detail. In FIG. 38, the blanket 16 female end projection 82 with the locking plate 86 attached is positioned over the channel 20 initially. This positions the locking plate for engaging the slot 28 in channel 20 and for the projection 82 for insertion initially into the channel 20. This arrangement is also shown in FIGS. 39 and 40 in sequence. In FIG. 40 the locking plate 86 is in position in the slot 28 and the plate 86 is resting on the bottom wall 30. As best seen in FIG. 1e, the locking plate 86 has a recess 92 centrally thereof which accommodates the mechanism of apparatus 14 such as boss 194 of the locking bar assembly 132. Also the locking plate 86 has a rear lip 195, FIGS. 1e and 3, which engages the anvil slot 28, FIG. 40.

In FIG. 41, which corresponds to step E, FIG. 37, with the female end 60 locked in place to the channel 20 and slot 28, the male end 62 is wrapped about the anvil 12 and placed in position adjacent to the locking apparatus 14.

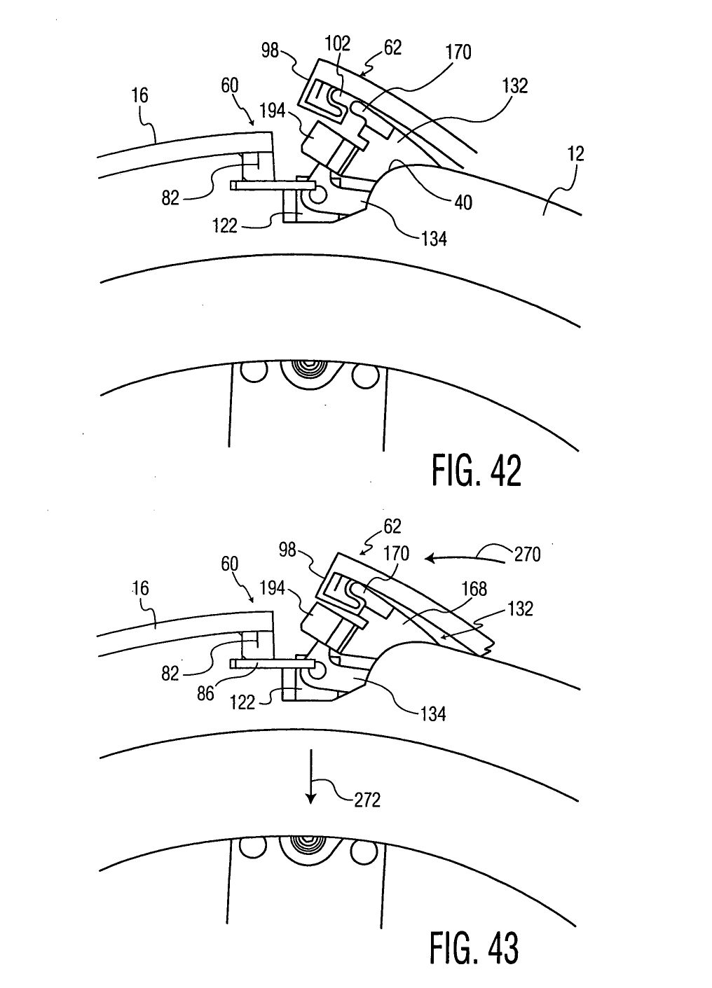

In FIGS. 42 and 43, the male end 62 recess 102 in the male projection 98 is manually engaged with the nose piece 170. This is relatively easy to do and requires no tools or special effort on the part of the installer person. This locking of the recess 102 to the nose piece is achieved in a relatively short time. At this time, the control panel 217, FIG. 35, for operating the air cylinder assemblies 116 is set in the unlocked state. Pressurized air is supplied to the assemblies to maintain the cylinders in the raised unlocked. In this state, the toggle 268, FIG. 35, is moved to the raise position to set the 3 way valve 242, FIG. 12, in the raised position (not shown in FIG. 35) via line 246. This pressure is shown by gauge 224.

The knob 233 is in the unlocked position rotated from the position shown in FIG. 35. The valve 232 is closed by knob 233 to allow pressurized air to be applied to the locking cylinder 119. The high pressure knob 263 is in the open position as shown, which opens the dump valve 262 so that no high pressure air is supplied to the cylinder 117. Low pressure air is supplied, via line 240, to the locking cylinder 119, FIGS. 35 and 36, since valve 232 is closed. This pressurized air keeps the locking cylinder unlocked against the bias of spring 111 in the locking cylinder 119. The gauge 260 registers atmospheric pressure at this time since valve 262 is open.

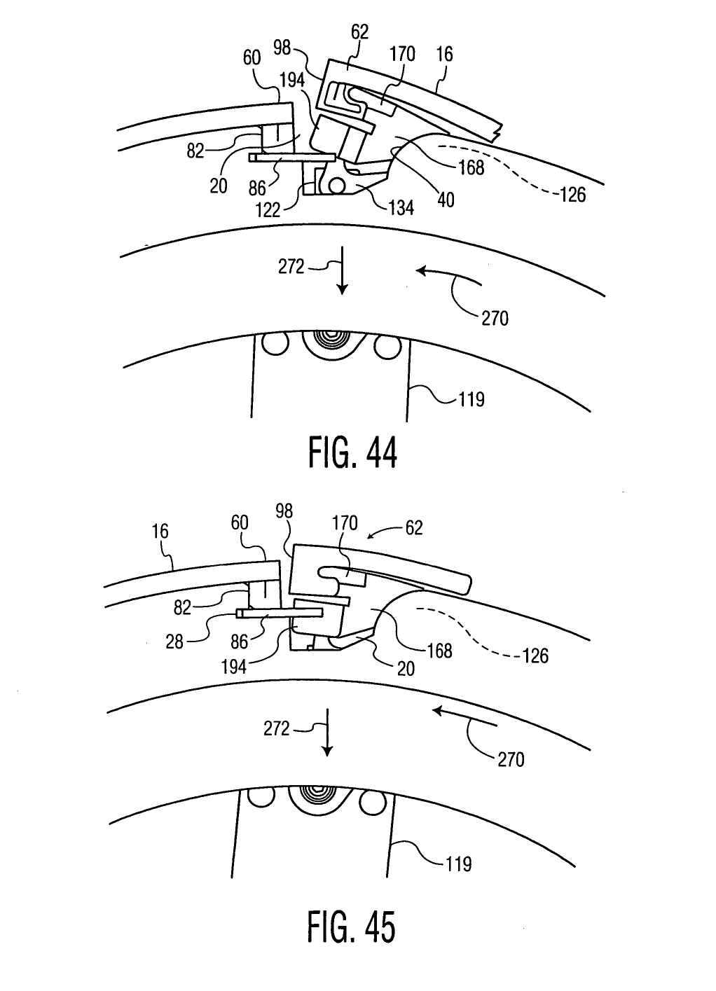

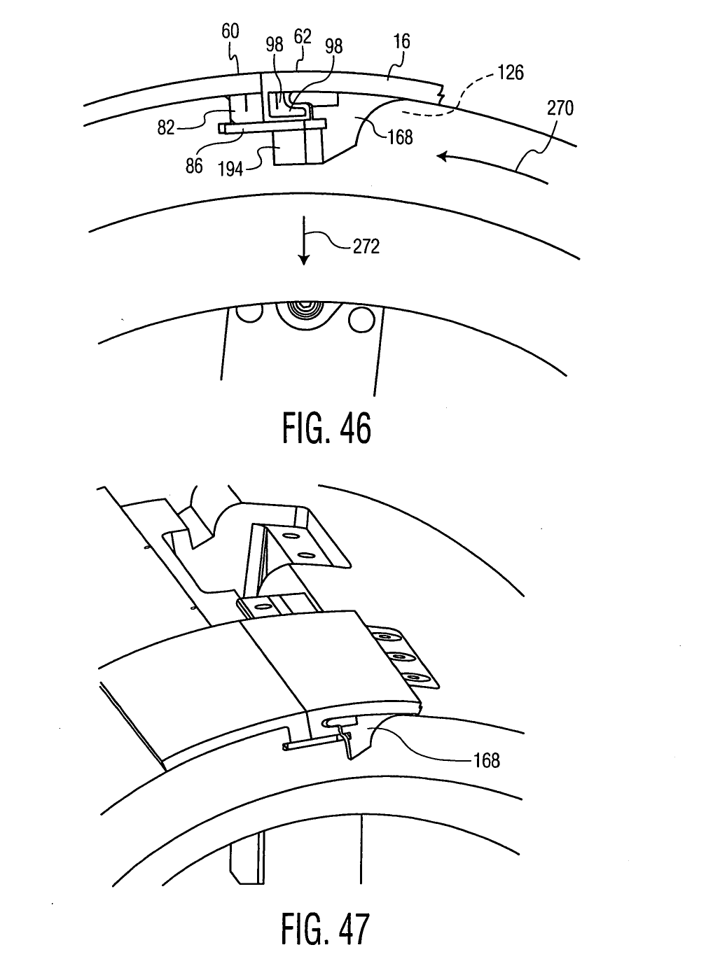

At this time, the dump valve 263, FIGS. 35 and 36, is closed by knob 263. The toggle 268 is then operated to place the 3 way valve 242 in position to apply pressurized input air to the pressure doubler 250. This applies doubled high pressure to lines 252, 258 and 266. Line 258 is blocked by the closed dump valve 263. This results in high pressure air being applied to the cylinder 117 and lowers the locking bar assembly 132. This action is reflected in FIGS. 44-47, FIGS. 46 and 47 showing the blanket 16 in the lowermost locking position. At this time, the locking knob 233 is rotated to the lock position. This closes valve 232. The pressurized air at 80-90 psig ((36.3-40.85 kg) at the inlet is thus applied to the locking piston of the locking cylinder 119. This air pressure displaces the locking piston 121 against the shaft 122 of the cylinder 117 to frictionally lock this shaft 122 in the lowered locked state.

In the lowered lock state, the blanket 16 male and female ends are abutting and the projections 82 and 98 are fully seated in the channel. The projection 98 of the male end is seated on top of the locking plate 86 at the female blanket end 60. This is because a major portion of the male projection 98 is overlying the channel 20 so that the locking plate supports the male projection when seated in the lowered locked position. A major portion of the locking plate 86 supports the male projection notwithstanding the recess 92 (FIG. 1e) in the locking plate that is centrally located to accommodate the linkage and so on of apparatus 14. Preferably the blanket 16 is one foot (30.5 cm) wide and corresponds exactly to the length of the locking bar 168. In FIG. 47, only one blanket is shown for simplicity of illustration. In practice, a full array of eight blankets would be simultaneously locked in place to the anvil 12.

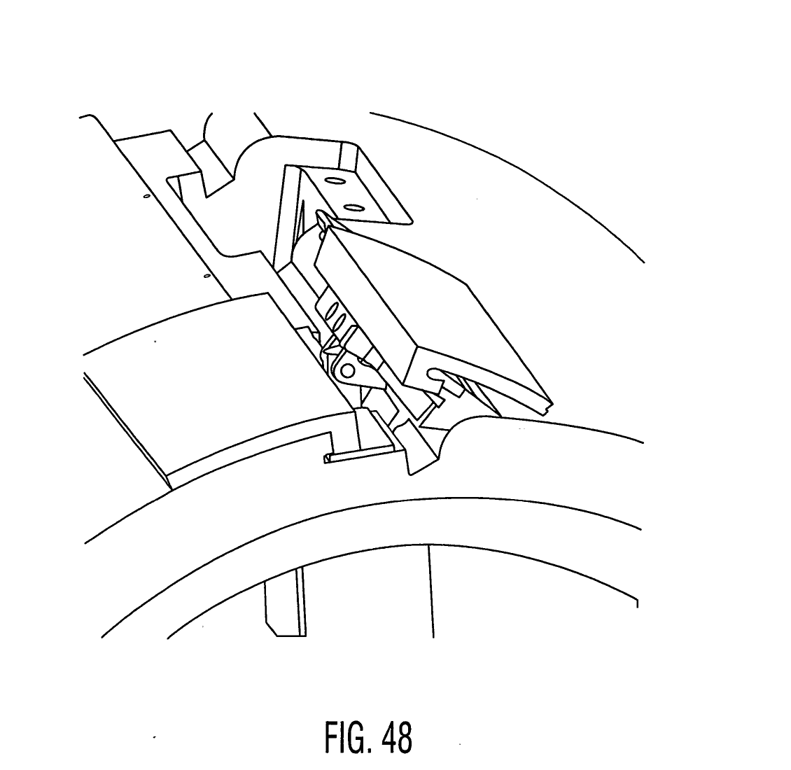

As should be plain from the examination of the FIGS. 37-47, the male end 62 is pulled simultaneously in a circumferential direction 270 parallel to the anvil 12 circumference and in a radial direction 272 normal to the circumferential direction. FIG. 48 shows the blanket when raised to the unlocked state by reversing the procedure described above.

Once the blanket is locked as shown in FIG. 47, the air lines to the anvil at fittings 273, FIG. 35, are disconnected from the mating anvil fittings via quick connect-disconnect fittings (not shown). This allows the anvil 12 and secured blanket 16 and associated apparatuses 14 to rotate. Without such disconnection of the air lines, of course the air lines would be damaged by such rotation. In the alternative, a pressurized air slip ring (not shown) could be used to attach the air lines from the supply lines to the anvil air lines. The slip ring would permit the anvil to rotate while the supply lines would remain stationary. Prior to disconnecting the air lines, all pressurized air in the various lines 240, 246 and 266 is removed by operation of the various knobs and toggle on the control panel 217, FIG. 35.

By disconnecting the air lines, high pressure air is no longer applied to the cylinder 117 in the lowered blanket secured locked state. However, by removing the air as was already done in respect of line 240 by opening the valve 232, the spring 111 of the locking cylinder 119 is engaged with the shaft 122 of the primary cylinder 117 keeping its shaft lowered in the locked state. Thus no pressurized air is required to maintain the blanket male projection 98 in the lowered locked state. The locking piston 119 ensures this locked state is maintained.

To unlock the blanket, the previously open valve 232, FIGS. 35, 36, is closed by rotating knob 233 to apply pressure to the piston 121 to overcome the locking bias of locking spring 111. This unlocks the locking piston 121 of locking cylinder 119 and releases the shaft 122 of the primary cylinder 117 for raising the shaft 122. Pressurized air is applied on line 246 to raise the shaft 122 and rotate the locking bar assembly 132 to the upper raised state of FIG. 48. This requires that the toggle 268 be operated to displace the 3 way valve to achieve this action. This removes the pressured air from lines 248, 252 and 256, FIG. 36.

Both rotating and radially displacing the male end simultaneously, overcomes and solves the problem with the inventor's prior aforementioned U.S. Pat. No. 6,612,214 discussed above. It will be recalled that problem is that the prior system was not able to pull on the blanket ends into the anvil channel sufficiently tight to form a good stable die cutting surface on the blanket. Apparently, pulling on the blanket ends only in the radial direction with available pressurized air and corresponding air cylinders commercially available was not sufficient to fully seat the de[pending projections into the mating anvil channel. This is not to say that other mechanisms not disclosed in that patent could not apply the needed force to so seat the ends. The present invention provides instead a different solution to that problem

In FIG. 2, anvil 18 is foreshortened to hold two blankets of the same one foot width (30.5 cm). This anvil may be used as a prototype for investigative purposes. Two locking apparatuses 14 are attached to this anvil to secure the two blankets 16 in side by side abutting relation. The anvil 18 has an annular support ring 19 at each end of the anvil (one ring being shown). A gusset plate 21 is attached to each of the support rings 19 at opposite anvil ends. An anvil drive shaft 23 is secured to the gusset plates at each anvil end. In similar fashion, shafts (not shown) are secured to the anvil 12 of FIGS. 1 and 2.

In the claims the term actuator may include the disclosed air cylinders or any other mechanical device for providing the claimed motions. for example, electrically activated solenoids can also provide linear displacements of a shaft. Gears and other drive mechanisms also may be used to provide the desired motions. For example, a rack and pinion arrangement can provide linear displacement similar to that of an air cylinder shaft. Rotating or otherwise displaceable pins and mating grooves in rotating wheels, discs or other devices also are alternative motion imparting mechanisms. While a three bar linkage is disclosed for attaching the air cylinder assembly to the anvil, other linkage arrangements are also contemplated and are within the skill of those of ordinary skill in the mechanism art.

It should be noted that the end faces of the projections and the end faces of the corresponding respective blanket ends are coplanar. Also these end faces abut for the entire region of the end faces in the locked state. However, these end faces do not engage in an interengaged locking mode. The female end is initially locked to the anvil via the locking plate lip and mating anvil recess or equivalent wedge shaped anvil recess and wedge shape of the projection. This initial locking action is independent of the locking action of the male end which is provided by the locking apparatus 14. Thus the initial locking of the female end is thus provided independently of the locking of the male end. The locking of the male end to the channel by the pneumatic apparatus which is also independent of the female end initial locking also locks the female end to the channel via the locking plate 86 attached to the female projection. However, the mating end faces do not interlock in complementary fashion as occurs with most prior art blanket locking systems shown in many of the documents noted in the introductory portion.

The resulting automatic locking of the ends of the blanket to the anvil thus eliminates the prior art tedious, time consuming and laborious operation of hammering the male projection into the channel recess into interlocking engagement with the female projection. This also avoids the tedious time consuming and difficult effort required to manually disengage the locked ends of the prior art. By operating some simple controls the blanket can be automatically locked to and released from the anvil. The temporary initial attachment of the blanket to the anvil prior to use of the automatic apparatus and reverse process of manually disengaging the blanket from the anvil after the apparatus releases the male end is now performed manually relatively quickly and with ease without tools. Hours of laborious labor is reduced to minutes in the changeover of the eight blankets attached to an anvil.

It will occur to one of ordinary skill in this art that various modifications and different embodiments may be made to the disclosed embodiments without departing from the spirit and scope of the invention. The disclosed embodiments are for illustration and not limitation and are intended to be only exemplary. For example, the female end can also be manipulated by an apparatus 14 if desired, but would be more costly than the disclosed embodiment. Also the rotating nose piece and mating recess may be configured differently than that shown so as to receive a recess facing in a different oriwentation than that disclosed. This may require some modification of the locking bar displacement motions. Such modifications are within the skill of those of ordinary skill in this art. The invention is defined by the appended claims.

1. A blanket locking system for releasably locking a die cutter blanket to an anvil comprising:
a cylindrical anvil for rotating about an axis and having a channel extending across its outer surface in a direction parallel to the anvil axis;
a die cutter blanket having first and second ends, the blanket for wrapping about and being releasably locked to the anvil outer surface in a locked state, the ends abutting in the locked state to form a continuous outer cylindrical die cutting surface, a first projection depending from the first blanket end and a second projection depending from the second blanket end for engagement with the anvil channel in a locked state; and
a blanket locking apparatus secured to the anvil arranged for selective engagement with the second projection for displacing only the engaged second projection into and out of the anvil channel to and from the locked state to thereby lock both projections in the channel.

2. The system of claim 1 wherein the locking apparatus is arranged for both circumferentially and radially displacing the engaged second projection.

3. The system of claim 1 wherein the anvil has a locking recess in communication with the channel, the first projection having a configuration complementary to the locking recess.

4. The system of claim 3 including a locking plate secured to the first projection for supporting the locked second projection in the channel.

5. The system of claim 3 including a locking plate for engaging the locking recess to releasably secure the first end to the anvil channel in the locked state.

6. The system of claim 3 including a removable strip attached to the anvil for forming the locking recess.

7. The system of claim 1 wherein the projections depend from the blanket a maximum given distance, each projection defining a face area over said entire given distance, the face areas mating with each other in abutting non-locking relationship.

8. The system of claim 1 wherein the apparatus includes a pneumatic arrangement for selectively placing the apparatus in the locked and unlocked states.

9. The system of claim 1 wherein the apparatus includes an actuator and a blanket locking bar pivotally secured to the anvil, the locking bar having a nose arranged to releasably engage a recess in the second projection, the actuator for rotating the locking bar during the displacing of the second projection to and from the locked and unlocked states for performing simultaneous circumferential and radial displacement of the second projection.

10. The system of claim 9 wherein the anvil channel has an arcuate corner portion surface, the locking bar having an arcuate surface that mates with and slidably rotates on said arcuate corner portion surface.

11. The system of claim 10 wherein the apparatus includes a locking bar mounting base secured to the anvil, the mounting base forming a portion of said channel arcuate corner portion surface.

12. The system of claim 1 including a mounting base secured to the anvil and having a first surface forming a corner of a portion of said channel, a locking bar engaged with the second projection having a second surface that mates with and slides on the mounting base first surface during the displacement to and from the locked and unlocked states, and an actuator for displacing the locking bar.

13. The system of claim 12 wherein the first and second surfaces are arcuate.

14. The system of claim 12 wherein the locking bar actuator is pivotally secured to the mounting base.

15. The system of claim 14 wherein the actuator comprise a reciprocating shaft, the shaft being pivotally secured to the locking bar for displacing the locking bar in response to the reciprocation of the shaft.

16. The system of claim 15 wherein the actuator is a pneumatically operated air cylinder.

17. The system of claim 1 including a plurality of said apparatuses secured to the anvil in a linear array.

18. The system of claim 17 including a control for simultaneous operation of said plurality of apparatuses.

19. The system of claim 1 wherein the apparatus includes a pressurized air operated actuator for positioning the second projection in the locked and unlocked states, a control for operating the actuator and responsive to a first pressurized air source having a first pressure value and a second pressurized air source having a pressure value that is greater than the first pressure value, the second pressure value for placing the actuator in the locked state, the first pressure for placing the actuator in the unlocked state.

20. The system of claim 1 including a locking bar, a locking recess is in the blanket second end at the second projection, the apparatus including an actuator secured to the anvil at the channel for operating the locking bar, the actuator including a nose for engaging the locking recess, the nose being attached to the locking bar which is displaced by the actuator between a raised unlocked state and a lowered lock state relative to the anvil wherein the second projection is drawn into the channel by the locking bar in the lowered lock state.

21. The system of claim 20 wherein the actuator includes a pressurized air operated cylinder having a reciprocating shaft, a link pivotally secured to the anvil and to the actuator shaft and fixedly secured to the locking bar wherein reciprocation of the shaft rotates the link and locking bar between the locked and unlocked states.

22. The system of claim 1 wherein the channel has a bottom wall, a surface of the recess and a surface of the bottom wall being coplanar, the bottom wall terminating at an opening in the channel, the opening for receiving a portion of the apparatus, a locking plate having a forward section extending over a portion of the opening, the second projection for abutting the locking plate extended forward section in the locked state.

23. The system of claim 22 wherein the received apparatus portion in the opening includes a pressurized air operated cylinder and piston arranged to be secured to the anvil.

24. The system of claim 16 wherein the air operated cylinder has a first piston and includes a locking cylinder having a second piston for locking air operated cylinder in the locked state with the second piston engaged with the first piston without the use of air pressure to maintain the locked state of the air operated cylinder.

25. The system of claim 24 wherein the locking cylinder includes a bias spring for biasing the second piston in the engaged first piston locking state without use of the air pressure to maintain the locked stated.

26. An apparatus for locking a die cutter blanket to a rotatable anvil having a channel in its outer surface extending parallel to the anvil axis of rotation, the blanket having opposing mating first and second abutting ends each with mating first and second respective depending projections for engaging the channel in a locked state, the blanket for wrapping about the anvil to form a continuous cylindrical smooth uninterrupted outermost blanket die cutting surface, the first end for manual releasable engagement with the channel, the second end having a locking recess, the apparatus for engaging the recess to lock the projections to the channel in the locked state, the apparatus comprising:
a blanket locking element having locked and unlocked states movably secured to the anvil for releasable engagement with the locking recess of the second end; and
an actuator secured to the anvil for displacing the element from the unlocked state into the locked state to lock the first and second projections to the anvil in the anvil channel and for reversing the displacement of the element to an unlocked state for releasing the blanket from the anvil.

27. The apparatus of claim 26 including a locking bar secured to the nose, the locking bar for circumferential and radial displacement relative to the anvil, the actuator including a piston and a link pivotally connected to the piston and to the anvil and secured fixed to the locking bar for displacing the locking bar and nose.

28. The apparatus of claim 26 including a mounting base arranged to be secured to the anvil, the base having a first arcuate surface forming a corner portion of the anvil channel, the locking bar having a second arcuate surface that mates with the first arcuate surface and slides on the first arcuate surface as the element and bar are rotated.

29. A die cutter blanket for wrapping about a rotatable cylindrical anvil having a channel in its outer peripheral surface extending parallel to the anvil axis of rotation, the channel having opposing side walls and a bottom wall having a surface terminating at opposite edges, one edge terminating at an anvil side wall and the opposing edge terminating at an opening in the anvil in communication with the channel, the blanket comprising:
a sheet material die cutting member having first and second mating ends which abut when wrapped about the anvil to form a circular cylinder having a smooth continuous outer die cutting surface;
a first projection depending from the blanket first end and terminating at a first projection bottom surface;
a second projection depending from the blanket second end; and
a locking plate secured to and juxtaposed with the first projection bottom surface, the plate extending from the first projection in a first extension, the first extension extending beyond the first projection and beyond the blanket first end for overlying the opening in the anvil and for receiving and supporting the second projection in overlying abutting relationship;
the second projection and blanket at the second end having a second recess having an opening thereto facing in a direction away from the first projection.

30. The blanket of claim 29 wherein the first and second projections depend from the blanket sheet material member a maximum distance forming a corresponding projection face forming a face region, the face regions for abutting in non-locking engagement over their entire maximum distance.

31. A blanket locking system for releasably locking a die cutter blanket to an anvil that rotates about an axis and has a channel extending across its surface in a direction parallel to the anvil axis of rotation, the system comprising:
a die cutter blanket having first and second ends, the blanket for wrapping about and being releasably locked to the anvil in a locked state wherein the ends abut to form a continuous cylindrical smooth uninterrupted blanket die cutting surface in the locked state, a first projection depending from the first blanket end and a second projection depending from the second blanket end, the first projection for being releasably secured in the channel while the blanket is manually wrapped about the anvil in an unlocked state, the second projection at the second end for engagement with the anvil channel in the locked state; and
an apparatus secured to the anvil for engagement only with the second projection in the unlocked state, the apparatus for displacing the engaged second projection into the locked state to lock the first and second projections in said anvil channel with the first and second ends of the blanket abutting and for selectively displacing the second projection into the unlock state to thereby permit the blanket to be released.

32. A die cutter anvil-blanket locking assembly comprising:
a plastic sheet material die cutter blanket having first and second ends, the blanket for wrapping about and being releasably locked to the anvil, each end having a projection depending from the blanket;
a roller anvil having an outer cylindrical surface and a longitudinal axis about which it rotates, the anvil having an axially extending channel in the outer surface, the blanket being wrapped about the anvil outer surface with the first and second ends abutting each other at least at said outer surface to form a continuous outer surface, the projections being located in the channel; and
an apparatus secured to the anvil for displacing one of the projections from an unlocked state into a locked state in the channel to lock both the first and second projections in the anvil channel.

33. The assembly of claim 32 wherein the apparatus is arranged to displace the one projection to a release position in an unlocked state.

34. An apparatus for locking a die cutter blanket to a rotatable anvil, the blanket having a continuous outer work surface encircling the anvil and one end with a locking recess, the apparatus comprising:
a blanket locking element having locked and unlocked states movably secured to the anvil for releasable engagement only with the blanket locking recess; and
an actuator secured to the anvil for displacing the element from the unlocked state into the locked state to lock the blanket to the anvil and for displacing the element to an unlocked state to permit release of the blanket from the anvil.
